(19) United States
(12) Patent Application Publication
(10) Pub. No.: US 2021/0131039 A1
(43) Pub. Date: May 6, 2021

(54) BINDER COMPOSITION AND METHOD COMPRISING MICROFIBRILLATED CELLULOSE AND RECYCLED CELLULOSIC MATERIALS

(71) Applicant: FIBERLEAN TECHNOLOGIES LIMITED, PAR (GB)

(72) Inventors: Sean IRELAND, Hampden, ME (US); Yun JIN, St. Austell (GB); Thomas Philip LARSON, St. Austell (GB); David Robert SKUSE, Truro (GB)

(73) Assignee: FIBERLEAN TECHNOLOGIES LIMITED, PAR (GB)

(21) Appl. No.: 17/084,016

(22) Filed: Oct. 29, 2020

Related U.S. Application Data
(63) Continuation of application No. PCT/US2020/057911, filed on Oct. 29, 2020.
(60) Provisional application No. 62/930,774, filed on Nov. 5, 2019.

(51) Int. Cl. D21J 3/12; D21B 1/32; D21B 1/34; D21H 17/67; D21J 1/16

(52) U.S. Cl. CPC D21J 3/12; D21B 1/32; D21J 1/16; D21H 17/675; D21B 1/345

(57) ABSTRACT

Methods of manufacturing a sheet or a board comprising recycled cellulose-containing materials, a binder composition comprising microfibrillated cellulose and one or more inorganic particulate material, and optionally one or more additive, wherein the sheet or board has an increased modulus of elasticity and modulus of rupture compared to a board prepared in a comparable method without microfibrillated cellulose, and to board, panel and construction products manufactured therefrom.

### BACKGROUND

### Field of Invention

The present invention relates to methods of manufacturing a board or sheet comprising recycled cellulose-containing materials, a binder composition comprising microfibrillated cellulose and one or more inorganic particulate material, and optionally one or more additives.

The present invention also relates to binder compositions comprising microfibrillated cellulose and one or more inorganic particulate materials and methods of using such binder compositions for manufacturing boards and sheets comprising recycled cellulose-containing materials, such as recycled pulp (for example old corrugated cardboard), or a papermill broke and/or industrial waste, or a paper stream rich in mineral fillers and cellulosic materials from a papermill and combinations thereof, and to material composites, boards, panels, sheets and construction products manufactured from such recycled cellulose-containing materials and binder compositions.

End-products obtained from such methods have better physical properties, including improved modulus of elasticity (“MOE”) and modulus of rupture (“MOR”) compared to end-products manufactured without binder compositions comprising microfibrillated cellulose and one or more inorganic particulate materials.

### Background of the Invention

Medium-density fiberboard (MDF) is an engineered wood product manufactured from defibrated hardwood and softwood and other components such as waxes and resins. MDF boards are ubiquitous composite products utilized in many end-applications, for example, in the manufacture of furniture and components of furniture, as well as interior construction materials.

MDF boards are formed into panels by applying high temperatures and pressures. MDF boards are denser than plywood and stronger and denser than particle board. However, when cut MDF releases dust particles into the air and potentially gaseous formaldehyde, which is typically used in resins employed to bind fibres in the MDF. The environmental concerns relating to MDF boards relates to the binders used in their manufacture, which, as noted, typically contain formaldehyde. Formaldehyde is able to gas-off for years, and coating the MDF to prevent escape of formaldehyde only locks the problem away. Landfills are the usual drop-off point for MDF materials; thus, the contaminants can continue to leach out of the MDF for years, potentially contaminating groundwater.

On the other hand, the recycling of cellulose pulp containing articles, such as old corrugated cardboard (OCC), is emerging as an environmental challenge, as well. If suitable composite materials can be produced from recycled pulp or a papermill broke and/or industrial waste, or paper streams rich in mineral fillers and cellulosic materials from a papermill collectively referred to as “recycled cellulose-containing materials,” to manufacture formable board and sheet materials from such recycled cellulose-containing materials and binder compositions comprising microfibrillated cellulose and inorganic particulate material, such a process could achieve a cost-effective and environmentally sensitive replacement for MDF products.

Prior art methods of manufacturing microfibrillated cellulose include mechanical disintegration by refining, milling, beating and homogenizing, and refining, for example, by an extruder. These mechanical measures may be enhanced by chemical or chemo-enzymatic treatments as a preliminary step. Various known methods of microfibrillation of cellulosic fibres are summarized in U.S. Pat. No. 6,602,994 B1 as including e.g. homogenization, steam explosion, pressurization-depressurization, impact, grinding, ultrasound, microwave explosion, milling and combinations of these. WO 2007/001229 discloses enzyme treatment and, as a method of choice, oxidation in the presence of a transition metal for turning cellulosic fibres to MFC. After the oxidation step the material is disintegrated by mechanical means. A combination of mechanical and chemical treatment can also be used. Examples of chemicals that can be used are those that either modify the cellulose fibers through a chemical reaction or those that modify the cellulose fibers via e.g. grafting or sorption of chemicals onto/into the fibers.

Various methods of producing microfibrillated cellulose (“MFC”) are known in the art. Certain methods and compositions comprising microfibrillated cellulose produced by grinding procedures are described in WO-A-2010/131016. Husband, J. C., Svending, P., Skuse, D. R., Motsi, T., Likitalo, M., Coles, A., FiberLean Technologies Ltd., 2015, “Paper filler composition,” PCT International Application No. WO-A-2010/131016. Paper products comprising such microfibrillated cellulose have been shown to exhibit excellent paper properties, such as paper burst and tensile strength. The methods described in WO-A-2010/131016 also enable the production of microfibrillated cellulose economically.

WO 2007/091942 A1 describes a process, in which chemical pulp is first refined, then treated with one or more wood degrading enzymes, and finally homogenized to produce MFC as the final product. The consistency of the pulp is taught to be preferably from 0.4 to 10%. The advantage is said to be avoidance of clogging in the high-pressure fluidizer or homogenizer.

WO2010/131016 describes a grinding procedure for the production of microfibrillated cellulose with or without inorganic particulate material. Such a grinding procedure is described below. In an embodiment of the process set forth in WO-A-2010/131016, the contents of which is hereby incorporated by reference in its entirety, the process utilizes mechanical disintegration of cellulose fibres to produce microfibrillated cellulose (“MFC”) cost-effectively and at large scale, without requiring cellulose pre-treatment. An embodiment of the method uses stirred media detritor grinding technology, which disintegrates fibres into MFC by agitating grinding media beads. In this process, a mineral such as calcium carbonate or kaolin is added as a grinding aid, greatly reducing the energy required. Husband, J. C., Svending, P., Skuse, D. R., Motsi, T., Likitalo, M., Coles, A., FiberLean Technologies Ltd., 2015, “Paper filler composition,” U.S. Pat. U.S. Pat. No. 9,127,405B2.

A stirred media mill consists of a rotating impeller that transfers kinetic energy to small grinding media beads, which grind down the charge via a combination of shear, compressive, and impact forces. A variety of grinding apparatus may be used to produce MFC by the disclosed methods herein, including, for example, a tower mill, a screened grinding mill, or a stirred media detritor.

### SUMMARY OF THE INVENTION

In accordance with the description, Figures, examples and claims of the present specification, the inventors have discovered processes for the manufacture of boards and sheets comprising recycled cellulose-containing materials, a binder composition comprising microfibrillated cellulose and one or more inorganic particulate material, and optionally one or more additive, as well as use of boards and sheets in a variety of boards, panels and construction products.

The present invention is based on the use of binder compositions comprising microfibrillated cellulose and inorganic particulate materials (sometimes referred to herein as “minerals”) in recycled cellulose-containing materials to prepare boards and sheets from such recycled cellulose-containing materials for the ultimate production of end products comprising such boards and sheets. Such end products include, for example, furniture and furniture components, including desks, storage units, cupboard units, modular furniture units, couches, chairs, recliners and numerous other furniture items. Other potential end-use applications include interior construction materials, including, for example, ceiling tiles, wallboards and insulation boards.

An alternative aspect of the invention is based on the use of binder compositions comprising microfibrillated cellulose without inorganic particulate materials (sometimes referred to herein as “minerals”) in recycled cellulose-containing materials to prepare boards and sheets from such recycled cellulose-containing materials for the ultimate production of end products comprising such boards and sheets. Such end products include, for example, furniture and furniture components, including desks, storage units, cupboard units, modular furniture units, couches, chairs, recliners and numerous other furniture items. Other potential end-use applications include interior construction materials, including, for example, ceiling tiles, wallboards and insulation boards.

An advantage of the present process is the production of boards and sheets from recycled cellulose-containing materials, which may themselves be recycled at the end of their service life, thereby providing a circular life cycle to the article made from the boards and sheets of the present invention. The impact on landfills alone would be enormous.

In another aspect of the present invention, the recycled cellulose-containing materials can be used in the production of microfibrillated cellulose used in the binder compositions, thereby further achieving the environmental objectives of utilizing recycled cellulose-containing materials and producing end-use products which may also be recycled.

Thus, microfibrillated cellulose used in the boards and sheets produced by the inventive process may be produced either from recycled cellulose-containing materials or from virgin pulps comprising, for example, recycled cellulose-containing materials. In either case, the end-product can be produced in a fully recyclable manner.

In a further aspect a binder composition may be prepared and used in recycled cellulose-containing materials comprising recycled pulp or a papermill broke and/or industrial waste, or a paper streams rich in mineral fillers and cellulosic materials from a papermill, that are processed into boards or sheets for further end use applications. The processing may include, for example, compression moulding and press forming.

In another aspect of the present disclosure, preferred end use applications are the manufacture of cellulose-containing board, sheet and construction products. These include the fabrication of furniture and furniture components as well as construction products of various types, such as, ceiling tiles, wallboards and insulation boards.

In an embodiment of the aspects and embodiments of the present disclosure, boards and sheets may be formed into the shape of a structural component using compression molding. The structural component may be used in furniture or in an office structure. Examples of a structural component include part of a frame for a couch, chair, or recliner, while examples of an office structure include a cubicle wall or bulletin board. Other examples are identified in the claims and examples following this description.

In an embodiment of the aspects and embodiments of the present disclosure, the microfibrillated cellulose may be prepared in manners known the art, such as by mechanical methods such as refining, homogenizing, grinding, defibrating, or optionally utilizing other chemical or enzymatic means.

Another aspect of the present invention is a method of manufacturing a board or sheet comprising recycled cellulose-containing materials, a binder composition comprising microfibrillated cellulose and one or more inorganic particulate material, and optionally one or more additives, the method comprising the steps of:

(a) providing or obtaining a first aqueous slurry of recycled cellulose-containing materials, wherein the aqueous slurry is disintegrated at a consistency of 0.1 wt. % to 10 wt. %;
(b) providing or obtaining a second aqueous slurry of microfibrillated cellulose and one or more inorganic particulate materials, wherein the ratio of the one or more inorganic particulate materials to microfibrillated cellulose is about 99:5:0.5 to about 0.5:99.5, wherein the microfibrillated cellulose is obtained from virgin pulp or recycled cellulose-containing materials;
(c) mixing the first aqueous slurry of recycled cellulose-containing materials and second aqueous slurry of microfibrillated cellulose and one or more inorganic particulate material at a consistency of 0.1 to 25 wt. %, and adding any optional additives, wherein the mixture comprises 0.5 wt. % to 25 wt. % microfibrillated cellulose and one or more inorganic particulate material;
(d) pumping the mixture of step (c) to a suitably sized mould or former, the mould or former optionally comprising a press;
(e) draining and/or pressing and drying the board or sheet, wherein the board or sheet has an increased modulus of elasticity and modulus of rupture compared to a board or sheet prepared in a comparable method without microfibrillated cellulose.

A further aspect of the present invention is a method of manufacturing a board or sheet comprising recycled cellulose-containing materials, a binder composition comprising microfibrillated cellulose and one or more inorganic particulate material, and optionally one or more additive, the method comprising the steps of:

(a) providing or obtaining a first aqueous slurry of old corrugated cardboard, wherein the aqueous slurry is disintegrated at a consistency of 0.1 wt. % to 10 wt. %;
(b) providing or obtaining a second aqueous slurry of microfibrillated cellulose and one or more inorganic particulate materials, wherein the ratio of the one or more inorganic particulate materials to microfibrillated cellulose is about 99.5:0:5 to about 0.5:99.5, wherein the microfibrillated cellulose is obtained from virgin pulp or recycled cellulose-containing materials;
(c) mixing the first aqueous slurry of recycled cellulose-containing materials and second aqueous slurry of microfibrillated cellulose and one or more inorganic particulate material at a consistency of 0.1 to 25 wt. %, and adding any optional additives, wherein the mixture comprises 0.5 wt. % to 25 wt. % microfibrillated cellulose and one or more inorganic particulate material;
(d) pumping the mixture of step (c) to a suitably sized mould or former, the mould or former optionally comprising a press;
(e) draining and/or pressing and drying the board, wherein the board has an increased modulus of elasticity and modulus of rupture compared to a board prepared in a comparable method without microfibrillated cellulose.

In an embodiment of the preceding aspects and embodiments of the present disclosure, the recycled cellulose-containing materials are selected from the group consisting of recycled pulp or a papermill broke and/or industrial waste, or a paper streams rich in mineral fillers and cellulosic materials from a papermill, or a combination thereof.

In an embodiment of the preceding aspects and embodiments of the present disclosure, the recycled cellulose-containing materials are old corrugated cardboard.

In an embodiment of the preceding aspects and embodiments of the present disclosure, the first aqueous slurry is disintegrated at a consistency of about 1, 2, 3 or 4 wt. %.

In an embodiment of the preceding aspects and embodiments of the present disclosure, the mixture of step (c) comprises about 0.5 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, or about 25 wt. %, microfibrillated cellulose and one or more inorganic particulate material.

In an embodiment of the preceding aspects and embodiments of the present disclosure, the microfibrillated cellulose is added in an amount of 5-100 kg, preferably 10-80 kg, more preferably 15-70 kg and most preferably 15-50 kg on dry basis per ton of dry solids of the stock.

In an embodiment of the preceding aspects and embodiments of the present disclosure, the microfibrillated cellulose and additive is a pre-mixture of microfibrillated cellulose, one or more inorganic particulate materials and a strength additive which is added to the thick stock flow of a paper machine at a consistency of 2-6%, more preferably 3-5% by weight.

In an embodiment of the preceding aspects and embodiments of the present disclosure, the disintegrating may be performed in a disintegrator, refiner or pulper or by other comparable means known in the art.

In an embodiment of the preceding aspects and embodiments of the present disclosure, the disintegrating is performed until the CSF of the recycled cellulose-containing materials is from about 20-700 CSF

In an embodiment of the preceding aspects and embodiments of the present disclosure, the disintegrating further comprises treating the slurry in a deflaker.

In an embodiment of the preceding aspects and embodiments of the present disclosure, the ratio of the one or more inorganic particulate materials to microfibrillated cellulose is about 80:20 to about 50:50.

In an embodiment of the preceding aspects and embodiments of the present disclosure, the ratio of the one or more inorganic particulate materials to microfibrillated cellulose is about 80:20, about 85:15, or about 90:10, or about 91:9, or about 92:8, or about 93:7, or about 94:6, or about 95:5, or about 96:4, or about 97:3, or about 98:2, or about 99:1, or about 50:50.

In an embodiment of the preceding aspects and embodiments of the present disclosure, the amount of inorganic particulate materials and cellulose pulp in the mixture to be co-ground may vary in a ratio of from about 99.5:0.5 to about 0.5:99.5, based on the dry weight of inorganic particulate materials and the amount of dry fibre in the pulp.

In an embodiment of the preceding aspects and embodiments of the present disclosure, the composition does not include fibres too large to pass through a BSS sieve (in accordance with BS 1796) having a nominal aperture size of 150 μm, for example, a nominal aperture size of 125 μm, 106 μm, or 90 μm, or 74 μm, or 63 μm, or 53 μm, 45 μm, or 38 μm. In one embodiment, the aqueous suspension is screened using a BSS sieve having a nominal aperture of 125 μm.

In an embodiment of the preceding aspects and embodiments of the present disclosure, the aqueous slurries and suspensions of microfibrillated cellulose and inorganic particulate material and other optional additives may include a dispersant, biocide, suspending aids, salt(s) and other additives, for example, starch or carboxymethylcellulose or polymers, which may facilitate the interaction of mineral particles and fibres during or after grinding.

In an embodiment of the preceding aspects and embodiments of the present disclosure, strengthening agents such as fixing or amphoteric starch, chitin, guar gum, carboxymethyl cellulose, and any mixture thereof, may be optionally utilized. Exemplary strengthening agents include: Wet end potato starch (commercially available from company Chemigate, product name Raisamyl™ 50021). Various cationic cook-up starches are known in the art, for example, starches from Solam such as SOLBOND™, including SOLBOND PC™ based on potato, SOLBOND LC™ based on pea, SOLBOND WC™ based on wheat, SOLBOND PWC™ based on potato and wheat, SOLBOND SBC™, based on potato and pea and SOLBOND N™, cold water soluble cationic starches. Other starches which may be employed include Maize Stach BP (unmodified native starch) and Pearl Dent Unmodified Starch. Another form of cationic starch known in the art is Excelcat 300™ cationic starch available from SMS Corporation. An anionic starch known in the art is Anchor™ LR Acid Modified Corn Starch.

Fixing agents known in the art include: CATIOFAST™ (159, 160, BP Liquid), FP, GM, PR 8154S, SF, VFH, VLH, VLW, VMP and VSH, which are available from BTC Chemical Distribution.

Strength additives are chemicals that improve paper strength such as strength compression strength, bursting strength and tensile breaking strength. The strength additives act as binders of fibers and thus also increase the interconnections between the fibers.

In an embodiment of the preceding aspects and embodiments of the present disclosure, strengthening agents may be optionally employed, for example, one or more synthetic polymer selected from cationic polyacrylamide (C-PAM), glyoxalated polyacrylamide (G-PAM), amphoteric polyacrylamide, polydiallyldimethylammonium chloride (poly-DADMAC), polyacrylic amide (PAAE), polyvinyl amine (PVAm), polyethylene oxide (PEO), polyethyleneimine (PEI) or a mixture of two or more of these polymers.

In an embodiment of the preceding aspects and embodiments of the present disclosure, the synthetic polymer may be a copolymer of methacrylamide or acrylamide and at least one cationic monomer. An exemplary synthetic strengthening agent is Fb 46 (commercially available from company Kemira, product name Fennobond™ 46 (cationic polyacrylamide based resin)).

In an embodiment of the preceding aspects and embodiments of the present disclosure, the additive may be an intermediate molecular mass or low molecular mass cationic, anionic, zwitzerionic or amphoteric coagulant.

In an embodiment of the preceding aspects and embodiments of the present disclosure, a synthetic strengthening aid having an average molecular weight in the range 100,000-20,000,000 g/mol, typically 300,000-8,000,000 g/mol, more typically 300,000-1,500,000 g/mol, may be optionally employed.

In an embodiment of the preceding aspects and embodiments of the present disclosure, the strengthening agent is added in an amount of 5-100 kg, preferably 10-80 kg, more preferably 15-70 kg and most preferably 15-50 kg on dry basis per ton of dry solids of the stock.

In an embodiment of the preceding aspects and embodiments of the present disclosure, a cationic retention polymer is a cationic polyacrylamide having an average molecular weight of 4,000,000-18,000,000 Da, preferably 4,000,000-12,000,000 Da, more preferably 7,000 000-10,000,000 Da, and/or having a charge density of 0.2-2.5 meq/g, preferably 0.5-1.5 meq/g, more preferably 0.7-1.2 meq/g.

In an embodiment of the preceding aspects and embodiments of the present disclosure, the inorganic particulate material may have a particle size distribution such that at least about 10% by weight, for example at least about 20% by weight, for example at least about 30% by weight, for example at least about 40% by weight, for example at least about 50% by weight, for example at least about 60% by weight, for example at least about 70% by weight, for example at least about 80% by weight, for example at least about 90% by weight, for example at least about 95% by weight, or for example about 100% of the particles have an equivalent spherical diameter (e.s.d.) of less than 2 μm.

In an embodiment of the preceding aspects and embodiments of the present disclosure, the additive may be a microparticle, for example, bentonite (commercially available from company Kemira, product name Altonit™ SF), Silica (commercially available from company Kemira, product name Fennosil™ 517). Other bentonites known in the art include CEDOSORB™ (E43, M18, M2 and VR1) available from BTC Chemical Distribution, as well as HYDROCOL™ (BU, HBB, OC, OM2, OM@LS, OM6, OM6LS, ACK and SH), also available from BTC Chemical Distribution.

The term “microparticle” as used in this specification includes solid, water insoluble, inorganic particles of nano-size or micro-size. A typical average particle diameter of a colloidal microparticle is from 10⁻⁶ mm to 10⁻³ mm.

The microparticle comprises inorganic colloidal microparticles. Preferably the inorganic colloidal microparticle comprises a silica-based microparticle, a natural silicate microparticle, a synthetic silicate microparticle, or mixtures thereof. Typical natural silicate microparticles are e.g. bentonite, hectorite, vermiculite, baidelite, saponite and sauconite. Typical synthetic silicate microparticles are e.g. fumed or alloyed silica, silica gel and synthetic metal silicates, such as silicates of Mg and Al type.

In an embodiment of the preceding aspects and embodiments of the present disclosure, the microparticle is a silica-based microparticle, a natural silicate microparticle, such as bentonite or hectorite, a synthetic silicate microparticle, or mixture thereof. In another embodiment, the microparticle is silica-based microparticle or bentonite. Typically the silica-based microparticle is added in an amount of 0.1-4 kg, preferably 0.2-2 kg, more preferably 0.3-1.5 kg, still more preferably 0.33-1.5 kg, even more preferably 0.33-1 kg, most preferably 0.33-0.8 kg on dry basis per ton of dry solids of the stock.

In an embodiment of the preceding aspects and embodiments of the present disclosure, the silica-based microparticle is added in an amount of at least 0.33 kg, preferably 0.33-4 kg, more preferably 0.33-2 kg, and most preferably 0.33-1.5 kg on dry basis per ton of dry solids of the stock.

Typically the natural or synthetic silicate-based microparticle is added in an amount of 0.1-10 kg, preferably 1-8 kg, more preferably 2-5 kg on dry basis per ton of dry solids of the stock.

In an embodiment of the preceding aspects and embodiments of the present disclosure, the inorganic particulate material may have a particle size distribution, as measured by a Malvern Mastersizer S machine, such that at least about 10% by volume, for example at least about 20% by volume, for example at least about 30% by volume, for example at least about 40% by volume, for example at least about 50% by volume, for example at least about 60% by volume, for example at least about 70% by volume, for example at least about 80% by volume, for example at least about 90% by volume, for example at least about 95% by volume, or for example about 100% by volume of the particles have an equivalent spherical diameter (e.s.d.) of less than 2 μm.

In an embodiment of the preceding aspects and embodiments of the present disclosure, the laser light scattering may be performed with a Malvern Insitec apparatus.

In an embodiment of the preceding aspects and embodiments of the present disclosure, the inorganic particulate material is an alkaline earth metal carbonate, for example, calcium carbonate. The inorganic particulate material may be ground calcium carbonate (GCC) or precipitated calcium carbonate (PCC), or a mixture of GCC and PCC. In another embodiment, the inorganic particulate material is a naturally platy mineral, for example, kaolin. The inorganic particulate material may be a mixture of kaolin and calcium carbonate, for example, a mixture of kaolin and GCC, or a mixture of kaolin and PCC, or a mixture of kaolin, GCC and PCC.

In an embodiment of the preceding aspects and embodiments of the present disclosure, the at least one or more inorganic particulate material is selected from the group consisting of magnesium carbonate, dolomite, gypsum, halloysite, ball clay, metakaolin, fully calcined kaolin, talc, mica, perlite, diatomaceous earth, magnesium hydroxide, aluminium trihydrate, or combinations thereof.

In an embodiment of the preceding aspects and embodiments of the present disclosure, of the aspects of the invention, some or all of the at least one inorganic particulate material is added with the recycled cellulose-containing materials of step (a).

In an embodiment of the preceding aspects and embodiments of the present disclosure, the aqueous suspension of microfibrillated cellulose is treated to remove at least a portion or substantially all of the water to form a partially dried or essentially completely dried product. For example, at least about 10% by volume of water in the aqueous suspension may be removed from the aqueous suspension, for example, at least about 20% by volume, or at least about 30% by volume, or least about 40% by volume, or at least about 50% by volume, or at least about 60% by volume, or at least about 70% by volume or at least about 80% by volume or at least about 90% by volume, or at least about 100% by volume of water in the aqueous suspension may be removed. Any suitable technique can be used to remove water from the aqueous suspension including, for example, by gravity or vacuum-assisted drainage, with or without pressing, or by evaporation, or by filtration, or by a combination of these techniques. The partially dried or essentially completely dried product will comprise microfibrillated cellulose and inorganic particulate material and any other optional additives that may have been added to the aqueous suspension prior to drying. The partially dried or essentially completely dried product may be optionally re-hydrated and incorporated in board or sheet compositions and other paper products, as described herein.

In an embodiment of the preceding aspects and embodiments of the present disclosure, the partially dried or essentially completely dried microfibrillated cellulose and inorganic particulate material may be prepared in accordance with U.S. Pat. No. 10,435,482 the contents of which are hereby incorporated by reference in their entirety. The aqueous suspension of microfibrillated cellulose and inorganic particulate material, and optional additives, may be prepared by the procedures herein and then dewatered by one or means, including for example, dewatering by belt press, or a high pressure automated belt press, or a centrifuge, tube press, screw press or rotary press to produce a dewatered composition of microfibrillated cellulose and inorganic particulate material and optional additives, which dewatered composition is then dried by one or more of a fluidized bed dryer, microwave or radio frequency dryer, or a hot swept mill or dryer, cell mill or a multirotor cell mill or by freeze drying to produce a dried or partially dried microfibrillated cellulose and inorganic particulate material composition and optional additives which may then be re-dispersed by means known in the art.

In an embodiment of the preceding aspects and embodiments of the present disclosure, microparticles can be used to improve dewatering properties of stocks. The function of the microparticles appears to involve release of water from polyelectrolyte bridges, causing them to contract, and functioning as a link in bridges that involve macromolecules adsorbed on different fibers or fine particles. These effects create more streamlined paths for water to flow around the fibers. The tendency of microparticles to boost first-pass retention will tend to have a positive effect on initial dewatering rates.

In an embodiment of the preceding aspects and embodiments of the present disclosure, the dried or partially dried microfibrillated cellulose and inorganic particulate material composition and optional additives composition may be re-dispersed in accordance with the procedures set forth in WO 2018/193314, the contents of which are hereby incorporated by reference in their entirety.

In an embodiment of the preceding aspects and embodiments of the present disclosure, re-dispersing the dewatered, partially dried or essentially completely dried microfibrillated cellulose and inorganic particulate material composition and optional additives may be performed by adding a quantity of a suitable dispersing liquid to a tank having at least a first and a second inlet and an outlet, wherein the tank further comprises a mixer and a pump attached to the outlet; (b) adding a quantity of dewatered, partially dried or essentially completely dried microfibrillated cellulose to the tank through the first inlet in sufficient quantity to yield a liquid composition of microfibrillated cellulose and inorganic particulate material composition and optional additive at a desired solids concentration of 0.5 to 5% fibre solids; mixing the dispersing liquid and the dewatered, partially dried or essentially completely dried microfibrillated cellulose in the tank with the mixer to partially de-agglomerate and re-disperse the microfibrillated cellulose to form a flowable slurry; pumping the flowable slurry with the pump to an inlet of a flow cell, wherein the flow cell comprises a recirculation loop and one or more sonication probe in series and at least a first and a second outlet, wherein the second outlet of the flow cell is connected to the second inlet of the tank, thereby providing for a continuous recirculation loop providing for the continuous application of ultrasonic energy to the slurry for a desired time period and/or total energy, wherein the flow cell comprises an adjustable valve at the second outlet to create back pressure of the recirculated slurry, further wherein the liquid composition comprising microfibrillated cellulose of step (c) is continuously recirculated through the recirculation loop at an operating pressure of 0 to 4 bar and at a temperature of 20° C. to 50° C.; (e) applying an ultrasonic energy input to the slurry of 200 to 10,000 kWh/t continuously by the sonication probe at a frequency range of 19 to 100 kHz and at an amplitude of up to 60%, up to 100% or up to 200% to the physical limitations of the sonicator used for 1 to 120 minutes; (0 collecting the re-dispersed suspension comprising microfibrillated cellulose with enhanced tensile strength and/or viscosity properties from the first outlet of the flow cell in a suitable holding vessel.

In a further aspect of the invention, the board or sheet is formed into the shape of the structural component using compression molding; wherein the structural component is used in furniture or in an office structure.

In an embodiment of the preceding aspects and embodiments of the present disclosure, the structural component is part of a frame for a couch, chair, or recliner.

In an embodiment of the preceding aspects and embodiments of the present disclosure, the structural component is part of a desk, storage unit, cupboard unit or a modular furniture unit.

In an embodiment of the preceding aspects and embodiments of the present disclosure, board or sheet has improved strength to accept fasteners.

In an embodiment of the preceding aspects and embodiments of the present disclosure, the board or sheet is a ceiling tile, wall board, or insulation board.

In an embodiment of the preceding aspects and embodiments of the present disclosure, the board or sheet may be of multiply construction or a laminated board or sheet.

In an embodiment of the preceding aspects and embodiments of the present disclosure, the board or sheet is manufactured using one or more additive.

In an embodiment of the preceding aspects and embodiments of the present disclosure, the additive is a retention aid, drainage aid, formation aid, sizing aid or leveling aid.

In an embodiment of the preceding aspects and embodiments of the present disclosure, the retention aid is selected from medium-to-high charge density, very high molecular weight, cationic polymers (for example, PerForm™ PC930 available from Solenis, Wilmington, Del., USA).

In an embodiment of the preceding aspects and embodiments of the present disclosure, the formation aid is selected from dispersing agent which is anionic or nonionic (e.g., polyethylene oxide, anionic polyacrylamide

In an embodiment of the preceding aspects and embodiments of the present disclosure, the sizing aid is selected from paper sizing agents (modified starch, or other hydrocolloids for surface sizing; alkyl succinic anhydride, alkyl ketene dimer and rosin for internal sizing). Examples of sizing agents known in the art are: SAB™ (18 and 18/50 which are Polyaluminium Chloride (PAC), pH neutral paper sizing and Polyaluminium Chloride (PAC), pH acidic paper sizing, respectively, available form ADITYA BIRLA Chemicals. Other available sizing agents include BASOPLAST™ (250D, 270D, 285S, 420G, 450G, 88 Conc., and 90 Conc.), which are available from BASF. Also available is FENNOSIZE™ (AS, G, KD and RS) available from Kemira Oyj and HERCON™ WI 155 available from Solenis (Wilmington, Del., USA).

Other additives known in the art are: micropolymers of anionic polyacrylamide sold under the trademark FENNOPOL™ 8635, dearators and defoaming agents available as FENNOTECH™ from Kemira Oyj, and multicomponent retention systems comprising FennoPol™ (cationic polyacrylamides), FennoSil™ (anionic micro or linear polymeracrylamide), FennoLite™ (bentonite) and FennoSil™ (silica sol) technologies) available from Kemira Oyj.

Finally some further additives may include colloidal silica available as LEVASIL™ RD2180 from Akzo Nobel and coagulant available as NALCO™ 74528 from Nalco.

In an embodiment of the preceding aspects and embodiments of the present disclosure, the sheet or board may comprise a leveling aid.

In an embodiment of the preceding aspects and embodiments of the present disclosure, the board or sheet is a foam manufactured using one or more additive. An exemplary additive is expanded perlite. An additional agent additive is a foaming agent, such as sodium lauryl sulphate or baking powder.

In an embodiment of the preceding aspects and embodiments of the present disclosure, the board or sheet has an increased modulus of elasticity of at least 5% and/or increased modulus of rupture of at least 5% compared to a board prepared in a comparable method without microfibrillated cellulose.

In an embodiment of the preceding aspects and embodiments of the present disclosure, the board or sheet has an increased modulus of elasticity of at least 10% and/or increased modulus of rupture of at least 10% compared to a board prepared in a comparable method without microfibrillated cellulose

In an embodiment of the preceding aspects and embodiments of the present disclosure, the board or sheet has an increased modulus of elasticity of at least 15% and/or increased modulus of rupture of at least 15% compared to a board prepared in a comparable method without microfibrillated cellulose.

In an embodiment of the preceding aspects and embodiments of the present disclosure, the board or sheet has an increased modulus of elasticity of at least 20% and/or increased modulus of rupture of at least 20% compared to a board prepared in a comparable method without microfibrillated cellulose.

In an embodiment of the preceding aspects and embodiments of the present disclosure, the board or sheet has an increased modulus of elasticity of at least 25% and/or increased modulus of rupture of at least 25% compared to a board prepared in a comparable method without microfibrillated cellulose.

In an embodiment of the preceding aspects and embodiments of the present disclosure, the board or sheet has an increased modulus of elasticity of at least 30% and/or increased modulus of rupture of at least 30% compared to a board prepared in a comparable method without microfibrillated cellulose.

In an embodiment of the preceding aspects and embodiments of the present disclosure, the microfibrillated cellulose has a fibre steepness of about 20 to about 50. In another embodiment, the fibre steepness range is about 25 to about 45. In a further embodiment, the fibre steepness range is about 30 to about 40.

In an embodiment of the preceding aspects and embodiments of the present disclosure, the board or sheet has a thickness or 1 to 25 mm.

In an embodiment of the preceding aspects and embodiments of the present disclosure, the board or sheet has a thickness or 2 to 5 mm.

In an embodiment of the preceding aspects and embodiments of the present disclosure, the board or sheet has a thickness or 3 to 4 mm.

In an embodiment of the preceding aspects and embodiments of the present disclosure, the board or sheet has a thickness or 5 to 10 mm.

In an embodiment of the preceding aspects and embodiments of the present disclosure, the board or sheet has a thickness or 10 to 15 mm.

In an embodiment of the preceding aspects and embodiments of the present disclosure, the board or sheet has a thickness or 20 to 25 mm.

In an embodiment of the preceding aspects and embodiments of the present disclosure, the additive is starch or carboxymethylcellulose.

In an embodiment of the preceding aspects and embodiments of the present disclosure, the additive is a rosin.

### BRIEF DESCRIPTION OF THE DRAWINGS

For a more complete understanding of the principles disclosed herein, and the advantages thereof, reference is made to the following descriptions taken in conjunction with the accompanying drawings, in which:

FIGS. 1A and 1B are plots of the change in filtrate mass over time (FIG. 1A) and change of water load of board over time (FIG. 1B).

FIGS. 2A-C present optical images of the piston pressed boards at 100 bar; (FIG. 2A) filter cloth side, (FIG. 2B) piston side, and (FIG. 2C) cross section.

FIGS. 3A-D are a selection of graphs depicting the initial drainage rate (FIG. 3A), normalised drainage time (FIG. 3B), moisture content (FIG. 3C) and density of the boards (FIG. 3D) at five pressing pressures and made from 100% OCC pulp.

FIG. 4 is a plot of MOR vs. board density. The dash lines are linear fitting curves for visual guidance.

FIGS. 5A-D is a plot of the effect of microfibrillated cellulose and inorganic particulate material dose on initial drainage rate (FIG. 5A), on normalised drainage time (FIG. 5B), on moisture content (FIG. 5C) and on drying rate constant (FIG. 5D).

FIGS. 6A-D is a plot of the effect of microfibrillated cellulose and inorganic particulate material dose on MOE (FIG. 6A), on MOR (FIG. 6B), on water uptake (FIG. 6C) and on thickness swelling (FIG. 6D).

FIG. 7 is a plot of MOR vs. board density. The dash lines are linear fitting curves for visual guidance.

FIG. 8 is a plot of MOR values in MPs of the various combinations of microfibrillated cellulose and the denominated minerals.

FIG. 9 is a summary of the production conditions and laboratory testing results for samples in Example 2.

### DETAILED DESCRIPTION OF THE INVENTION

The titles, headings and subheadings provided herein should not be interpreted as limiting the various aspects of the disclosure. Accordingly, the terms defined below are more fully defined by reference to the specification in its entirety. All references cited herein are incorporated by reference in their entirety.

The present invention relates to the preparation of a sheet or board comprising microfibrillated cellulose and one or more inorganic particulate material as a binder composition in such sheet or board, wherein such board is manufactured from recycled pulp or a papermill broke and/or industrial waste, or a paper streams rich in mineral fillers and cellulosic materials from a papermill, and optionally wherein the microfibrillated cellulose may also be prepared from recycled pulp or a papermill broke and/or industrial waste, or a paper streams rich in mineral fillers and cellulosic materials from a papermill. The present invention further relates to uses of sheets or boards, as aforesaid, in the manufacture of board products including furniture and components for furniture wherein the binder composition of microfibrillated cellulose and one or more inorganic particulate material improve the density and/or board strength of composite materials made from such sheets or boards.

Unless otherwise defined, scientific and technical terms used herein shall have the meanings that are commonly understood by those of ordinary skill in the art. Further, unless otherwise required by context, singular terms shall include pluralities and plural terms shall include the singular.

In this application, the use of “or” means “and/or” unless stated otherwise. In the context of a multiple dependent claim, the use of “or” refers back to more than one preceding independent or dependent claim in the alternative only.

It is further noted that, as used in this specification and the appended claims, the singular forms “a,” “an,” and “the,” and any singular use of any word, include plural referents unless expressly and unequivocally limited to one referent.

The instant invention is most clearly understood with reference to the following definitions:

The term “about” is used herein to mean approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%.

As used herein, the terms “comprising” (and any form of comprising, such as “comprise”, “comprises”, and “comprised”), “having” (and any form of having, such as “have” and “has”), “including” (and any form of including, such as “includes” and “include”), or “containing” (and any form of containing, such as “contains” and “contain”), are inclusive or open-ended and do not exclude additional, unrecited elements or method steps. Additionally, a term that is used in conjunction with the term “comprising” is also understood to be able to be used in conjunction with the term “consisting of” or “consisting essentially of.”

As used herein, the term “include” and its grammatical variants are intended to be non-limiting, such that recitation of items in a list is not to the exclusion of other like items that can be substituted or added to the listed items.

As used herein, the phrase “integer from X to Y” means any integer that includes the endpoints. For example, the phrase “integer from 1 to 5” means 1, 2, 3, 4, or 5.

As used herein, the term “biodegradable” as used herein refers to compositions that are degradable over time by water and/or enzymes found in nature, without any harmful effect on the environment. The compositions of the present disclosure exhibit properties that meet the requirements of ASTM D6868-11 “Standard Specification for Labeling of End Items that Incorporate Plastics and Polymers as Coatings or Additives” (ASTM International, West Conshohocken, Pa.). Alternatively, the compositions of the present disclosure exhibit properties that meet the requirements of ASTM D6400-04-“Specification for Compostable Plastics” (ASTM International, West Conshohocken, Pa.).

The term “strengthening agent” as used herein describes a material that when incorporated into a biodegradable composition improves one or more of the characteristic(s) of the composite formed therefrom as compared to the characteristic(s) exhibited by a similar composite formed using a composition without the strengthening agent. These characteristic(s) may include without limitation, stress at maximum load, fracture stress, fracture strain, modulus, modulus of elasticity, modulus of rupture, or toughness.

The term recycled cellulose-containing materials means recycled pulp or a papermill broke and/or industrial waste, or paper streams rich in mineral fillers and cellulosic materials from a papermill.

The present invention is related to modifications, for example, improvements, to the methods and compositions described in WO-A-2010/131016, the entire contents of which are hereby incorporated by reference.

WO-A-2010/131016 discloses a process for preparing microfibrillated cellulose comprising microfibrillating, e.g., by grinding, a fibrous material comprising cellulose, optionally in the presence of grinding medium and inorganic particulate material. When used as a filler in paper, for example, as a replacement or partial replacement for a conventional mineral filler, the microfibrillated cellulose obtained by said process, optionally in combination with inorganic particulate material improved the burst strength properties of the paper. That is, relative to a paper filled with exclusively mineral filler, paper filled with the microfibrillated cellulose was found to have improved burst strength. In other words, the microfibrillated cellulose filler was found to have paper burst strength enhancing attributes. In one particularly advantageous embodiment of that invention, the fibrous material comprising cellulose was ground in the presence of a grinding medium, optionally in combination with inorganic particulate material, to obtain microfibrillated cellulose having a fibre steepness of from 20 to about 50.

The method described in WO-A-2010/131016 comprises a step of microfibrillating a fibrous substrate comprising cellulose by grinding in the presence of a particulate grinding medium which is to be removed after the completion of grinding. By “microfibrillating” is meant a process in which microfibrils of cellulose are liberated or partially liberated as individual species or as small aggregates as compared to the fibres of the pre-microfibrillated pulp. Typical cellulose fibres (i.e., pre-microfibrillated pulp) suitable for use in papermaking include larger aggregates of hundreds or thousands of individual cellulose fibrils. By microfibrillating the cellulose, particular characteristics and properties, including the characteristics and properties described herein, are imparted to the microfibrillated cellulose and the compositions comprising the microfibrillated cellulose.

The fibrous substrate comprising cellulose (variously referred to herein as “fibrous substrate comprising cellulose,” “cellulose fibres,” “fibrous cellulose feedstock,” “cellulose feedstock” and “cellulose-containing fibres (or fibrous,” etc.) may be derived from recycled pulp or a papermill broke and/or industrial waste, or a paper streams rich in mineral fillers and cellulosic materials from a papermill.

The recycled cellulose pulp may be beaten (for example in a Valley beater) and/or otherwise refined (for example, processing in a conical or plate refiner) to any predetermined freeness, reported in the art as Canadian standard freeness (CSF) in cm³. CSF means a value for the freeness or drainage rate of pulp measured by the rate that a suspension of pulp may be drained, and this test is carried out according to the T 227 cm-09 TAPPI standard. For example, the cellulose pulp may have a Canadian standard freeness of about 10 cm³ or greater prior to being microfibrillated. The recycled cellulose pulp may have a CSF of about 700 cm³ or less, for example, equal to or less than about 650 cm³, or equal to or less than about 600 cm³, or equal to or less than about 550 cm³, or equal to or less than about 500 cm³, or equal to or less than about 450 cm³, or equal to or less than about 400 cm³, or equal to or less than about 350 cm³, or equal to or less than about 300 cm³, or equal to or less than about 250 cm³, or equal to or less than about 200 cm³, or equal to or less than about 150 cm³, or equal to or less than about 100 cm³, or equal to or less than about 50 cm³. The recycled cellulose pulp may have a CSF of about 20 to about 700. The recycled cellulose pulp may then be dewatered by methods well known in the art, for example, the pulp may be filtered through a screen in order to obtain a wet sheet comprising at least about 10% solids, for example at least about 15% solids, or at least about 20% solids, or at least about 30% solids, or at least about 40% solids. The recycled pulp may be utilized in an unrefined state, that is to say without being beaten or dewatered, or otherwise refined

In an embodiment, the microfibrillated cellulose may also be prepared from recycled pulp or a papermill broke and/or industrial waste, or a paper streams rich in mineral fillers and cellulosic materials from a papermill.

The fibrous substrate comprising cellulose may be added to a grinding vessel fibrous substrate comprising cellulose in a dry state. For example, a dry paper broke may be added directly to the grinder vessel. The aqueous environment in the grinder vessel will then facilitate the formation of a pulp.

In a preferred embodiment, OCC bales are dispersed in a pulper with water and an aqueous binder composition of microfibrillated cellulose and inorganic particulate material is added. The OCC and binder compositions is then transferred to a stock tank and then diluted and pumped to a head tank where a sizing agent may be added. An exemplary sizing agent is C-PAM however, other sizing agents may be employed as described elsewhere in the specification. The OCC pulp and binder composition is then transferred to a board mold. Wet boards are moved by conveyor tables into a press section, where the boards are pressed, and then dried in drying section of the apparatus. White water is recirculated.

### The Inorganic Particulate Material.

The inorganic particulate material, when present, may, for example, be an alkaline earth metal carbonate or sulphate, such as calcium carbonate, magnesium carbonate, dolomite, gypsum, a hydrous kandite day such as kaolin, halloysite or ball clay, an anhydrous (calcined) kandite clay such as metakaolin or fully calcined kaolin, talc, mica, perlite or diatomaceous earth, or magnesium hydroxide, or aluminium trihydrate, or combinations thereof.

A preferred inorganic particulate material for use in the method is calcium carbonate. Hereafter, the invention may tend to be discussed in terms of calcium carbonate, and in relation to aspects where the calcium carbonate is processed and/or treated. The invention should not be construed as being limited to such embodiments.

The particulate calcium carbonate used in the present invention may be obtained from a natural source by grinding. Ground calcium carbonate (GCC) is typically obtained by crushing and then grinding a mineral source such as chalk, marble or limestone, which may be followed by a particle size classification step, in order to obtain a product having the desired degree of fineness. Other techniques such as bleaching, flotation and magnetic separation may also be used to obtain a product having the desired degree of fineness and/or color. The particulate solid material may be ground autogenously, i.e. by attrition between the particles of the solid material themselves, or, alternatively, in the presence of a particulate grinding medium comprising particles of a different material from the calcium carbonate to be ground. These processes may be carried out with or without the presence of a dispersant and biocides, which may be added at any stage of the process.

Precipitated calcium carbonate (PCC) may be used as the source of particulate calcium carbonate in the present invention, and may be produced by any of the known methods available in the art. TAPPI Monograph Series No 30, “Paper Coating Pigments”, pages 34-35 describes the three main commercial processes for preparing precipitated calcium carbonate which is suitable for use in preparing products for use in the paper industry, but may also be used in the practice of the present invention. In all three processes, a calcium carbonate feed material, such as limestone, is first calcined to produce quicklime, and the quicklime is then slaked in water to yield calcium hydroxide or milk of lime. In the first process, the milk of lime is directly carbonated with carbon dioxide gas. This process has the advantage that no by-product is formed, and it is relatively easy to control the properties and purity of the calcium carbonate product. In the second process the milk of lime is contacted with soda ash to produce, by double decomposition, a precipitate of calcium carbonate and a solution of sodium hydroxide. The sodium hydroxide may be substantially completely separated from the calcium carbonate if this process is used commercially. In the third main commercial process the milk of lime is first contacted with ammonium chloride to give a calcium chloride solution and ammonia gas. The calcium chloride solution is then contacted with soda ash to produce by double decomposition precipitated calcium carbonate and a solution of sodium chloride. The crystals can be produced in a variety of different shapes and sizes, depending on the specific reaction process that is used. The three main forms of PCC crystals are aragonite, rhombohedral and scalenohedral, all of which are suitable for use in the present invention, including mixtures thereof.

Wet grinding of calcium carbonate involves the formation of an aqueous suspension of the calcium carbonate which may then be ground, optionally in the presence of a suitable dispersing agent. Reference may be made to, for example, EP-A-614948 (the contents of which are incorporated by reference in their entirety) for more information regarding the wet grinding of calcium carbonate.

In some circumstances, minor additions of other minerals may be included, for example, one or more of kaolin, calcined kaolin, wollastonite, bauxite, talc or mica, could also be present.

When the inorganic particulate material of the present invention is obtained from naturally occurring sources, it may be that some mineral impurities will contaminate the ground material. For example, naturally occurring calcium carbonate can be present in association with other minerals. Thus, in some embodiments, the inorganic particulate material includes an amount of impurities. In general, however, the inorganic particulate material used in the invention will contain less than about 5% by weight, preferably less than about 1% by weight, of other mineral impurities.

The inorganic particulate material used during the microfibrillating step of the method of the present invention will preferably have a particle size distribution in which at least about 10% by weight of the particles have an equivalent spherical diameter (e.s.d.) of less than 2 μm, for example, at least about 20% by weight, or at least about 30% by weight, or at least about 40% by weight, or at least about 50% by weight, or at least about 60% by weight, or at least about 70% by weight, or at least about 80% by weight, or at least about 90% by weight, or at least about 95% by weight, or about 100% of the particles have an e.s.d of less than 2 μm.

Unless otherwise stated, particle size properties referred to herein for the inorganic particulate materials are as measured in a well-known manner by sedimentation of the particulate material in a fully dispersed condition in an aqueous medium using a Sedigraph 5100 machine as supplied by Micromeritics Instruments Corporation, Norcross, Ga., USA (telephone: +1 770 662 3620; web-site: www.micromeritics.com), referred to herein as a “Micromeritics Sedigraph 5100 unit”. Such a machine provides measurements and a plot of the cumulative percentage by weight of particles having a size, referred to in the art as the ‘ equivalent spherical diameter’ (e.s.d), less than given e.s.d values. The mean particle size d₅₀ is the value determined in this way of the particle e.s.d at which there are 50% by weight of the particles which have an equivalent spherical diameter less than that d₅₀ value.

Alternatively, where stated, the particle size properties referred to herein for the inorganic particulate materials are as measured by the well-known conventional method employed in the art of laser light scattering, using a Malvern Mastersizer S machine as supplied by Malvern Instruments Ltd (or by other methods which give essentially the same result). In the laser light scattering technique, the size of particles in powders, suspensions and emulsions may be measured using the diffraction of a laser beam, based on an application of Mie theory. Such a machine provides measurements and a plot of the cumulative percentage by volume of particles having a size, referred to in the art as the ‘ equivalent spherical diameter’ (e.s.d), less than given e.s.d values. The mean particle size d₅₀ is the value determined in this way of the particle e.s.d at which there are 50% by volume of the particles which have an equivalent spherical diameter less than that d₅₀ value.

Unless otherwise stated, particle size properties of the microfibrillated cellulose materials are as are as measured by the well-known conventional method employed in the art of laser light scattering, using a Malvern Insitec L machine as supplied by Malvern Instruments Ltd (or by other methods which give essentially the same result).

Details of the procedure used to characterize the particle size distributions of mixtures of inorganic particle material and microfibrillated cellulose using a Malvern Mastersizer S machine are provided below.

Another preferred inorganic particulate material for use is kaolin clay. The invention should not be construed as being limited to such embodiments. Thus, in some embodiments, kaolin is used in an unprocessed form.

Kaolin clay used in this invention may be a processed material derived from a natural source, namely raw natural kaolin clay mineral. The processed kaolin clay may typically contain at least about 50% by weight kaolinite. For example, most commercially processed kaolin clays contain greater than about 75% by weight kaolinite and may contain greater than about 90%, in some cases greater than about 95% by weight of kaolinite.

Kaolin clay used in the present invention may be prepared from the raw natural kaolin clay mineral by one or more other processes which are well known to those skilled in the art, for example by known refining or beneficiation steps.

For example, the clay mineral may be bleached with a reductive bleaching agent, such as sodium hydrosulfite. If sodium hydrosulfite is used, the bleached clay mineral may optionally be dewatered, and optionally washed and again optionally dewatered, after the sodium hydrosulfite bleaching step.

The clay mineral may be treated to remove impurities, e.g. by flocculation, flotation, or magnetic separation techniques well known in the art. Alternatively the clay mineral used in the first aspect of the invention may be untreated in the form of a solid or as an aqueous suspension.

The process for preparing the particulate kaolin clay used in the present invention may also include one or more comminution steps, e.g., grinding or milling. Light comminution of a coarse kaolin is used to give suitable delamination thereof. The comminution may be carried out by use of beads or granules of a plastic (e.g. nylon), sand or ceramic grinding or milling aid. The coarse kaolin may be refined to remove impurities and improve physical properties using well known procedures. The kaolin clay may be treated by a known particle size classification procedure, e.g., screening and centrifuging (or both), to obtain particles having a desired d₅₀ value or particle size distribution

### Microfibrillated Cellulose

Microfibrillated cellulose comprises cellulose, which is a naturally occurring polymer comprising repeated glucose units. The term “microfibrillated cellulose,” also denoted MFC, as used in this specification includes microfibrillated/microfibrillar cellulose and nano-fibrillated/nanofibrillar cellulose (NFC), which materials are also called nanocellulose.

By “microfibrillating” is meant a process in which microfibrils of cellulose are liberated or partially liberated as individual species or as small aggregates as compared to the fibres of the pre-microfibrillated pulp. Typical cellulose fibres (i.e., pre-microfibrillated pulp) suitable for use in papermaking include larger aggregates of hundreds or thousands of individual cellulose fibrils.

Microfibrillated cellulose is prepared by stripping away the outer layers of cellulose fibres that may have been exposed through mechanical shearing, with or without prior enzymatic or chemical treatment. There are numerous methods of preparing microfibrillated cellulose that are known in the art.

Generally, the microfibrillating process, in one aspect, comprises microfibrillating a fibrous substrate comprising cellulose in the presence of an inorganic particulate material. According to particular embodiments of the present methods, the microfibrillating step is conducted in the presence of an inorganic particulate material which acts as a microfibrillating agent.

In certain embodiments, the composition comprising microfibrillated cellulose is obtainable by a process comprising microfibrillating a fibrous substrate comprising cellulose in the presence of a grinding medium. The process is advantageously conducted in an aqueous environment.

In a preferred embodiment, fibrous substrate comprising cellulose may be derived from recycled cellulose-containing materials, i.e., from recycled pulp or a papermill broke and/or industrial waste, or a paper streams rich in mineral fillers and cellulosic materials from a papermill, or a combination thereof.

The microfibrillating is carried out in the presence of grinding medium which acts to promote microfibrillation of the pre-microfibrillated cellulose. In addition, the inorganic particulate material may act as a microfibrillating agent, i.e., the cellulose starting material can be microfibrillated at relatively lower energy input when it is co-processed, e.g., co-ground, in the presence of an inorganic particulate material.

The fibrous substrate comprising cellulose may be in the form of a pulp (i.e., a suspension of cellulose fibres in water), which may be prepared by any suitable chemical or mechanical treatment, or combination thereof.

Unless otherwise stated, particle size properties of the microfibrillated cellulose materials are as are as measured by the well-known conventional method employed in the art of laser light scattering, using a Malvern Mastersizer S machine as supplied by Malvern Instruments Ltd (or by other methods which give essentially the same result).

Details of the procedure used to characterise the particle size distributions of mixtures of inorganic particle material and microfibrillated cellulose using a Malvem Mastersizer S machine are provided below.

The fibrous substrate comprising cellulose may be microfibrillated in the presence of an inorganic particulate material to obtain microfibrillated cellulose having a d₅₀ ranging from about 5 to μm about 500 μm, as measured by laser light scattering. The fibrous substrate comprising cellulose may be microfibrillated in the presence of an inorganic particulate material to obtain microfibrillated cellulose having a d₅₀ of equal to or less than about 400 μm, for example equal to or less than about 300 μm, or equal to or less than about 200 μm, or equal to or less than about 150 μm, or equal to or less than about 125 μm, or equal to or less than about 100 μm, or equal to or less than about 90 μm, or equal to or less than about 80 μm, or equal to or less than about 70 μm, or equal to or less than about 60 μm, or equal to or less than about 50 μm, or equal to or less than about 40 μm, or equal to or less than about 30 μm, or equal to or less than about 20 μm, or equal to or less than about 10 μm.

The fibrous substrate comprising cellulose may be microfibrillated in the presence of an inorganic particulate material to obtain microfibrillated cellulose having a modal fibre particle size ranging from about 0.1-500 μm and a modal inorganic particulate material particle size ranging from 0.25-20 μm. The fibrous substrate comprising cellulose may be microfibrillated in the presence of an inorganic particulate material to obtain microfibrillated cellulose having a modal fibre particle size of at least about 0.5 μm, for example at least about 10 μm, or at least about 50 μm, or at least about 100 μm, or at least about 150 μm, or at least about 200 μm, or at least about 300 μm, or at least about 400 μm.

The fibrous substrate comprising cellulose may be microfibrillated in the presence of an inorganic particulate material to obtain microfibrillated cellulose having a fibre steepness equal to or greater than about 10, as measured by Malvern. Fibre steepness i.e., the steepness of the particle size distribution of the fibres) is determined by the following formula:

Steepness=100×(d₃₀/d₇₀)

The microfibrillated cellulose may have a fibre steepness equal to or less than about 100. The microfibrillated cellulose may have a fibre steepness equal to or less than about 75, or equal to or less than about 50, or equal to or less than about 40, or equal to or less than about 30. The microfibrillated cellulose may have a fibre steepness from about 20 to about 50, or from about 25 to about 40, or from about 25 to about 35, or from about 30 to about 40.

The finer mineral peak can be fitted to the measured data points and subtracted mathematically from the distribution to leave the fibre peak, which can be converted to a cumulative distribution. Similarly, the fibre peak can be subtracted mathematically from the original distribution to leave the mineral peak, which can also be converted to a cumulative distribution. Both these cumulative curves may then be used to calculate the mean particle size (d₅₀) and the steepness of the distribution (d₃₀/d₇₀×100). The differential curve may then be used to find the modal particle size for both the mineral and fibre fractions

### Preparing the Aqueous Suspension of Microfibrillated Cellulose and Inorganic Particulate Material

In an embodiment, the aqueous suspensions of microfibrillated cellulose and inorganic particulate material and other optional additives may be made in the following manner. The other optional additives include dispersant, biocide, suspending aids, salt(s) and other additives, for example, starch or carboxymethyl cellulose or polymers, which may facilitate the interaction of mineral particles and fibres during or after grinding.

The inorganic particulate material may have a particle size distribution such that at least about 10% by weight, for example at least about 20% by weight, for example at least about 30% by weight, for example at least about 40% by weight, for example at least about 50% by weight, for example at least about 60% by weight, for example at least about 70% by weight, for example at least about 80% by weight, for example at least about 90% by weight, for example at least about 95% by weight, or for example about 100% of the particles have an e.s.d of less than 2 μm. In another embodiment, the inorganic particulate material may have a particle size distribution, as measured by a Malvem Mastersizer S machine, such that at least about 10% by volume, for example at least about 20% by volume, for example at least about 30% by volume, for example at least about 40% by volume, for example at least about 50% by volume, for example at least about 60% by volume, for example at least about 70% by volume, for example at least about 80% by volume, for example at least about 90% by volume, for example at least about 95% by volume, or for example about 100% by volume of the particles have an e.s.d of less than 2 μm.

The amount of inorganic particulate material and cellulose pulp in the mixture to be co-ground may vary in a ratio of from about 99.5:0.5 to about 0.5:99.5, based on the dry weight of inorganic particulate material and the amount of dry fibre in the pulp, for example, a ratio of from about 99.5:0.5 to about 50:50 based on the dry weight of inorganic particulate material and the amount of dry fibre in the pulp. For example, the ratio of the amount of inorganic particulate material and dry fibre may be from about 99.5:0.5 to about 70:30. In an embodiment, the ratio of inorganic particulate material to dry fibre is about 80:20, or for example, about 85:15, or about 90:10, or about 91:9, or about 92:8, or about 93:7, or about 94:6, or about 95:5, or about 96:4, or about 97:3, or about 98:2, or about 99:1. In a preferred embodiment, the weight ratio of inorganic particulate material to dry fibre is about 95:5. In another preferred embodiment, the weight ratio of inorganic particulate material to dry fibre is about 90:10. In another preferred embodiment, the weight ratio of inorganic particulate material to dry fibre is about 85:15. In another preferred embodiment, the weight ratio of inorganic particulate material to dry fibre is about 80:20

In an embodiment, the composition does not include fibres too large to pass through a BSS sieve (in accordance with BS 1796) having a nominal aperture size of 150 μm, for example, a nominal aperture size of 125 μm, 106 μm, or 90 μm, or 74 μm, or 63 μm, or 53 μm, 45 μm, or 38 μm. In one embodiment, the aqueous suspension is screened using a BSS sieve having a nominal aperture of 125 μm.

It will be understood therefore that amount (i.e., % by weight) of microfibrillated cellulose in the aqueous suspension after grinding or homogenizing may be less than the amount of dry fibre in the pulp if the ground or homogenized suspension is treated to remove fibres above a selected size. Thus, the relative amounts of pulp and inorganic particulate material fed to the grinder or homogenizer can be adjusted depending on the amount of microfibrillated cellulose that is required in the aqueous suspension after fibres above a selected size are removed.

In an embodiment, the inorganic particulate material is an alkaline earth metal carbonate, for example, calcium carbonate. The inorganic particulate material may be ground calcium carbonate (GCC) or precipitated calcium carbonate (PCC), or a mixture of GCC and PCC. In another embodiment, the inorganic particulate material is a naturally platy mineral, for example, kaolin. The inorganic particulate material may be a mixture of kaolin and calcium carbonate, for example, a mixture of kaolin and GCC, or a mixture of kaolin and PCC, or a mixture of kaolin, GCC and PCC.

Thus, in accordance with one embodiment, the fibrous substrate comprising cellulose and inorganic particulate material are present in the aqueous environment at an initial solids content of at least about 4 wt. %, of which at least about 2% by weight is fibrous substrate comprising cellulose. In some embodiments, the initial solids content may be at least about 0.25 wt. %, 0.5 wt. %, 1 wt. %, 1.5 wt. %, 2 wt. %, 2.5 wt. %, 3 wt. %, 4 wt. %, 5 wt. %. In some embodiments the initial solids content may be at least about 6 wt. %, 7 wt. %, 8 wt. %, 9 wt. % or about 10 wt. %. At least about 5% by weight of the initial solids content may be fibrous substrate comprising cellulose.

In another embodiment, the aqueous suspension is treated to remove at least a portion or substantially all of the water to form a partially dried or essentially completely dried product. For example, at least about 10% by volume of water in the aqueous suspension may be removed from the aqueous suspension, for example, at least about 20% by volume, or at least about 30% by volume, or least about 40% by volume, or at least about 50% by volume, or at least about 60% by volume, or at least about 70% by volume or at least about 80% by volume or at least about 90% by volume, or at least about 100% by volume of water in the aqueous suspension may be removed. Any suitable technique can be used to remove water from the aqueous suspension including, for example, by gravity or vacuum-assisted drainage, with or without pressing, or by evaporation, or by filtration, or by a combination of these techniques.

Pressing of boards may be carried out under different pressures of, for example, 1 to 150 bar with a form of hydraulic press (e.g., a piston press) in order to consolidate the boards and reduce the moisture content. Temperature of the water in this process can range from 10 to 90° C. —the higher temperature is expected to accelerate the drainage and increase the solid of the board before the dryer. The press section could be achieved with a hydraulic press mold or cylinder press on a full scale machine.

The drying process is conducted at elevated temperature in the oven (typically over 100° C.), which may be at about 130° C. On a larger scale, this could be carried out by a gas steam (thermal drying), vacuum drying, conductive drying (e.g. roll drying) or infrared drying.

In an embodiment of the preceding aspects and embodiments of the present disclosure, the fibrous substrate comprising cellulose is present in the aqueous environment at an initial solids content of less than about 5 wt %, or less than about 4 wt %, or less than about 3 wt %, or less than about 2 wt %, or less than about 1.5 wt %, or less than about 1 wt %, or less than about 0.5 wt %.

In an embodiment of the preceding aspects and embodiments of the present disclosure, the total amount of energy used in the method is less than about 10,000 kWh per tonne of dry fibre in the fibrous substrate comprising cellulose, or less than about 5,000 kWh per tonne of dry fibre in the fibrous substrate comprising cellulose, or less than about 3,000 kWh per tonne of dry fibre in the fibrous substrate comprising cellulose, or less than about 2,500 kWh per tonne of dry fibre in the fibrous substrate comprising cellulose, or less than about 2,000 kWh per tonne of dry fibre in the fibrous substrate comprising cellulose.

The total energy input in a typical grinding process to obtain the desired aqueous suspension composition may typically be between about 100 and 1500 kWht⁻¹ based on the total dry weight of the inorganic particulate filler. The total energy input may be less than about 1000 kWht⁻¹, for example, less than about 800 kWht⁻¹, less than about 600 kWht⁻¹, less than about 500 kWht⁻¹, less than about 400 kWht⁻¹, less than about 300 kWht⁻¹, or less than about 200 kWht⁻¹.

A cellulose pulp can be microfibrillated at relatively low energy input when it is co-ground in the presence of an inorganic particulate material. The total energy input per tonne of dry fibre in the fibrous substrate comprising cellulose will be less than about 10,000 kWht⁻¹, for example, less than about 9000 kWht⁻¹, or less than about 8000 kWht⁻¹, or less than about 7000 kWht⁻¹, or less than about 6000 kWht⁻¹, or less than about 5000 kWht⁻¹, for example less than about 4000 kWht⁻¹, less than about 3000 kWht⁻¹, less than about 2000 kWht⁻¹, less than about 1500 kWht⁻¹, less than about 1200 kWht⁻¹, less than about 1000 kWht⁻¹, or less than about 800 kWht⁻¹. The total energy input varies depending on the amount of dry fibre in the fibrous substrate being microfibrillated, and optionally the speed of grind and the duration of grind.

As the suspension of material to be ground may be of a relatively high viscosity, a suitable dispersing agent may preferably be added to the suspension prior to grinding. The dispersing agent may be, for example, a water soluble condensed phosphate, polysilicic acid or a salt thereof, or a polyelectrolyte, for example a water soluble salt of a poly(acrylic acid) or of a poly(methacrylic acid) having a number average molecular weight not greater than 80,000. The amount of the dispersing agent used would generally be in the range of from 0.1 to 2.0% by weight, based on the weight of the dry inorganic particulate solid material. The suspension may suitably be ground at a temperature in the range of from 4° C. to 100° C.

Other additives which may be included during the microfibrillation step include: carboxymethylcellulose, amphoteric carboxymethylcellulose, oxidising agents, 2,2,6,6-Tetramethylpiperidine-1-oxyl (TEMPO), TEMPO derivatives, and wood degrading enzymes.

The biodegradable composition may also optionally comprise an anti-moisture agent that inhibits moisture absorption by the renewable composite. This anti-moisture agent may also decrease any odors that result from the use of proteins. The anti-moisture agent may be any known wax or oil. Alternatively, the anti-moisture agent is a plant-based, petroleum-based, or animal-based wax or oil. The plant-based anti-moisture agent may be selected from the group comprising carnauba wax, tea tree oil, soy wax, soy oil, lanolin, palm oil, palm wax, peanut oil, sunflower oil, rapeseed oil, canola oil, algae oil, coconut oil, and carnauba oil. The petroleum-based anti-moisture agent may be selected from the group comprising paraffin wax, paraffin oil and mineral oil. The animal-based anti-moisture agent may be selected from the group comprising beeswax and whale oil.

The pH of the suspension of material to be ground may be about 7 or greater than about 7 (i.e., basic), for example, the pH of the suspension may be about 8, or about 9, or about 10, or about 11. The pH of the suspension of material to be ground may be less than about 7 (i.e., acidic), for example, the pH of the suspension may be about 6, or about 5, or about 4, or about 3.

The pH of the suspension of material to be ground may be adjusted by addition of an appropriate amount of acid or base. Suitable bases included alkali metal hydroxides, such as, for example NaOH. Other suitable bases are sodium carbonate and ammonia. Suitable acids included inorganic acids, such as hydrochloric and sulphuric acid, or organic acids. An exemplary acid is orthophosphoric acid

In an exemplary embodiment the partially dried or essentially dried microfibrillated cellulose and inorganic particulate material may be prepared in accordance with U.S. Pat. No. 10,435,482 the contents of which are hereby incorporated by reference in their entirety. The aqueous suspension of microfibrillated cellulose and inorganic particulate material, and optional additives, may be prepared herein and then dewatered by one or means, including for example, dewatering by belt press, or a high pressure automated belt press, or a centrifuge, tube press, screw press or rotary press to produce a dewatered composition of microfibrillated cellulose and inorganic particulate material and optional additives, which dewatered composition is then dried by one or more of a fluidized bed dryer, microwave or radio frequency dryer, or a hot sept mill or dryer, cell mill or a multirotor cell mill or by freeze drying to produce a dried or partially dried microfibrillated cellulose and inorganic particulate material composition and optional additives which may then be re-dispersed by means known in the art.

In an embodiment, the dried or partially dried microfibrillated cellulose and inorganic particulate material composition and optional additives composition may be re-dispersed in accordance with WO 2018/193314, the contents of which are hereby incorporated by reference in their entirety.

In an embodiment, re-dispersing the dewatered, partially dried or essentially dried microfibrillated cellulose and inorganic particulate material composition and optional additives may be performed by adding a quantity of a suitable dispersing liquid to a tank having at least a first and a second inlet and an outlet, wherein the tank further comprises a mixer and a pump attached to the outlet; (b) adding a quantity of dewatered, partially dried or essentially dried microfibrillated cellulose to the tank through the first inlet in sufficient quantity to yield a liquid composition of microfibrillated cellulose and inorganic particulate material composition and optional additive at a desired solids concentration of 0.5 to 5% fibre solids; mixing the dispersing liquid and the dewatered, partially dried or essentially dried microfibrillated cellulose in the tank with the mixer to partially de-agglomerate and re-disperse the microfibrillated cellulose to form a flowable slurry; pumping the flowable slurry with the pump to an inlet of a flow cell, wherein the flow cell comprises a recirculation loop and one or more sonication probe in series and at least a first and a second outlet, wherein the second outlet of the flow cell is connected to the second inlet of the tank, thereby providing for a continuous recirculation loop providing for the continuous application of ultrasonic energy to the slurry for a desired time period and/or total energy, wherein the flow cell comprises an adjustable valve at the second outlet to create back pressure of the recirculated slurry, further wherein the liquid composition comprising microfibrillated cellulose of step (c) is continuously recirculated through the recirculation loop at an operating pressure of 0 to 4 bar and at a temperature of 20° C. to 50° C.; (e) applying an ultrasonic energy input to the slurry of 200 to 10,000 kWh/t continuously by the sonication probe at a frequency range of 19 to 100 kHz and at an amplitude of up to 60%, up to 100% or up to 200% to the physical limitations of the sonicator used for 1 to 120 minutes; (f) collecting the re-dispersed suspension comprising microfibrillated cellulose with enhanced tensile strength and/or viscosity properties from the first outlet of the flow cell in a suitable holding vessel.

Homogenizing

In an embodiment of the preceding aspects and embodiments of the present disclosure, microfibrillation of the fibrous substrate comprising cellulose may be effected under wet conditions in the presence of the inorganic particulate material by a method in which the mixture of cellulose pulp and inorganic particulate material is pressurized (for example, to a pressure of about 500 bar) and then passed to a zone of lower pressure. The rate at which the mixture is passed to the low pressure zone is sufficiently high and the pressure of the low pressure zone is sufficiently low as to cause microfibrillation of the cellulose fibres. For example, the pressure drop may be effected by forcing the mixture through an annular opening that has a narrow entrance orifice with a much larger exit orifice. The drastic decrease in pressure as the mixture accelerates into a larger volume (i.e., a lower pressure zone) induces cavitation which causes microfibrillation. In an embodiment, microfibrillation of the fibrous substrate comprising cellulose may be effected in a homogenizer under wet conditions in the presence of the inorganic particulate material. In the homogenizer, the cellulose pulp-inorganic particulate material mixture is pressurized (for example, to a pressure of about 500 bar), and forced through a small nozzle or orifice. The mixture may be pressurized to a pressure of from about 100 to about 1000 bar, for example to a pressure of equal to or greater than 300 bar, or equal to or greater than about 500, or equal to or greater than about 200 bar, or equal to or greater than about 700 bar. The homogenization subjects the fibres to high shear forces such that as the pressurized cellulose pulp exits the nozzle or orifice, cavitation causes microfibrillation of the cellulose fibres in the pulp. Additional water may be added to improve flowability of the suspension through the homogenizer. The resulting aqueous suspension comprising microfibrillated cellulose and inorganic particulate material may be fed back into the inlet of the homogenizer for multiple passes through the homogenizer. In a preferred embodiment, the inorganic particulate material is a naturally platy mineral, such as kaolin. As such, homogenization not only facilitates microfibrillation of the cellulose pulp, but also facilitates delamination of the platy inorganic particulate material.

A platy inorganic particulate material, such as kaolin, is understood to have a shape factor of at least about 10, for example, at least about 15, or at least about 20, or at least about 30, or at least about 40, or at least about 50, or at least about 60, or at least about 70, or at least about 80, or at least about 90, or at least about 100. Shape factor, as used herein, is a measure of the ratio of particle diameter to particle thickness for a population of particles of varying size and shape as measured using the electrical conductivity methods, apparatuses, and equations described in U.S. Pat. No. 5,576,617, which is incorporated herein by reference.

A suspension of a platy inorganic particulate material, such as kaolin, may be treated in the homogenizer to a predetermined particle size distribution in the absence of the fibrous substrate comprising cellulose, after which the fibrous material comprising cellulose is added to the aqueous slurry of inorganic particulate material and the combined suspension is processed in the homogenizer as described above. The homogenization process is continued, including one or more passes through the homogenizer, until the desired level of microfibrillation has been obtained. Similarly, the platy inorganic particulate material may be treated in a grinder to a predetermined particle size distribution and then combined with the fibrous material comprising cellulose followed by processing in the homogenizer. An exemplary homogenizer is a Manton Gaulin (APV) homogenizer.

After the microfibrillation step has been carried out, the aqueous suspension comprising microfibrillated cellulose and inorganic particulate material may be screened to remove fibre above a certain size and to remove any grinding medium. For example, the suspension can be subjected to screening using a sieve having a selected nominal aperture size in order to remove fibres which do not pass through the sieve. Nominal aperture size means the nominal central separation of opposite sides of a square aperture or the nominal diameter of a round aperture. The sieve may be a BSS sieve (in accordance with BS 1796) having a nominal aperture size of 150 μm, for example, a nominal aperture size 125 μm, or 106 μm, or 90 μm, or 74 μm, or 63 μm, or 53 μm, 45 μm, or 38 μm. In one embodiment, the aqueous suspension is screened using a BSS sieve having a nominal aperture of 125 μm. The aqueous suspension may then be optionally dewatered.

An alternative method of preparing microfibrillated cellulose is disclosed in US 20190127911. A substantially dry composite material, comprising microfibrillated cellulose and a filler material, is prepared by precipitating filler material onto fibers or fibrils of said microfibrillated cellulose and providing an aqueous media. The process involves lowering the pH of the aqueous media and then mixing the aqueous media with the substantially dry composite material, before or after the step of lowering of the pH. The filler material is then released from the microfibrillated cellulose.

The cellulose pulp may then be dewatered by methods well known in the art, for example, the pulp may be filtered through a screen in order to obtain a wet sheet comprising at least about 10% solids, for example at least about 15% solids, or at least about 20% solids, or at least about 30% solids, or at least about 40% solids. The pulp may be utilised in an unrefined state, that is to say, without being beaten or dewatered, or otherwise refined.

The fibrous substrate comprising cellulose may be added to a grinding vessel in a dry state. For example, a dry paper broke may be added directly to the grinder vessel. The aqueous environment in the grinder vessel will then facilitate the formation of a pulp.

The step of microfibrillating may be carried out in any suitable apparatus, including but not limited to a refiner. In one embodiment, the microfibrillating step is conducted in a grinding vessel under wet-grinding conditions. In another embodiment, the microfibrillating step is carried out in a homogenizer.

In an embodiment of the preceding aspects and embodiments of the present disclosure, microfibrillated cellulose and inorganic particulate material in a high solids form, where water has been partially or essentially completely removed can be transported to a remote manufacturing site and then made down by re-dispersing the high solids binder composition in a suitable disperser or by other means as described in WO2018/193314, Microfibrillated Cellulose with Enhanced Properties and Method of Making Same, and WO 2017/182883 Redispersed Microfibrillated Cellulose, which are hereby incorporated by reference in its entirety.

Properties of the formable sheet materials comprising recycled pulps and a binder composition comprising microfibrillated cellulose and inorganic particulate material are optimally tested in accordance with the following methods which are known in the art.

Size and thickness (BS EN 324-1)

Density/Density variation (BS EN 323)

Bending Strength/Bending Elasticity Flexural rigidity/Stiffness (BS EN 310)

Internal Bond Strength (BS EN 319)

Dimensional stability (BS EN 318)

Swelling in thickness (BS EN 317)

Moisture content (BS EN 322)

Machinability/Squareness/Edge straightness (BS EN 324-2)

Resistance to screw withdrawal (BS EN 320)

Formaldehyde potential (BS EN 120)

### Examples

In order that this invention may be more fully understood, the following examples are set forth. These examples are for the purpose of illustrating embodiments of the invention, and are not to be construed as limiting the scope of the invention in any way.

### Example 1. Manufacture of Boards Comprising Old Corrugated Cardboard (“OCC”) and a Binder Composition Comprising Microfibrillated Cellulose (“MFC”) and Optionally One or More Inorganic Particulate Material

Total Percentage of Pulp Calculation.

The Total % POP was determined in the following manner.

The % POP (Percentage of Pulp) is the percentage mass of the total solids that is fibre.

An empty crucible to 4 decimal places (“dp”) was weighed. (W1). Immediately after the % solids determination takes place >1 g oven-dry product was added to the crucible and weighed to 4 dp (W2). Using the long handled tongs, the crucible was place in furnace at 950° C. for 30 mins and then removed and cooled in a desiccator, and thereafter reweighed to 4 dp. (W3).

The % POP is calculated in the following manner.

The percentage of pulp ‘% POP’ is expressed as the percentage mass of the total solids that is fibre and is given by:

For example if the MFC is fibrillated with kaolin

POP%=((W2−W1)−((W3−W1))/((1−LOI)))/((W2−W1))×100

Where W1=the weight of the crucible as recorded in 4.1

W2=the weight of the oven-dry product plus the crucible as recorded in 4.2

W3=the weight of ash plus crucible recorded in 4.4

LOI=loss on ignition factor (expressed as a fraction—e.g. 10% should be expressed as 0.1)

For kaolin, the typical loss on ignition factor at 950° C. is 0.14
For talc, the typical loss on ignition factor at 950° C. is 0.08
For calcined clay, the typical loss on ignition factor at 950° C. is zero
Ideally, the LOI of the specific mineral sample from which the sample was made should be measured, but typical values can be used instead where this is not available.
The standard deviation is 0.5 for % POP.

Old Corrugated Cardboard (“OCC”) (Product Code DSB205618, DS Smith) was refined for 20 minutes in 12 litres at 5 wt. % consistency in a large disintegrator. The binder composition comprised 50% percentage of pulp (POP) of Intramax™ 57 (IMAX57; available from Imerys Minerals Limited, United Kingdom) and FiberLean™ microfibrillated cellulose (MFC). IMAX 57 is a paper filler grade kaolin. The binder composition was centrifuged at 4600 rpm for 30 minutes, and the total solid content of the centrifuged binder composition was measured by moisture balance. A 0.1 wt. % anionic organic polymer retention aid (PERFORM™ PC930 available from Solenis, Wilmington, Del., USA) composition was prepared with distilled water using a rotating impeller.

The composition of the board slurry included the refined OCC pulp and/or MFC (FiberLean™) (see Table 1 below) at 50 percentage of pulp (POP), i.e., MFC and clay at a 50:50 ratio. Thus, for 10 wt. % of 50 POP MFC and clay, there is 5 wt. % MFC and 5 wt. % clay. Analogously, 20 wt. % of 50 POP MFC/clay comprises 10 wt. % MFC and 10 wt. % clay. The resultant slurry at 4 wt. % consistency was mixed with a flocculant (0.2 wt. % dose of anionic organic polymer retention aid (PERFORM™ PC930)(Solenis) on dried board mass, and then poured into a piston press with a total volume of 550 ml. Five pressure conditions were used to produce the boards: 40 bar, 60 bar, 80 bar, 100 bar and 120 bar.

Microfibrillated cellulose, OCC and additive were loaded into a piston cylinder and compacted by a pneumatic piston against a drainage gauze at the other end. The disk so formed was extracted, dried and tested. The rate at which water drains out of the device was a function of the applied pressure and is an important parameter as this impacts production rate and drying costs.

TABLE 1
Composition of board slurry

| | Composition | | | Retention Aid on |
|---|---|---|---|---|
| | OCC | 50% POP MFC | Total | dry board solid |
| Sample ID | wt. % | wt. % | wt. % | wt. % |
| PP1 | 100 | 0 | 100 | 0.2 |
| PP2 | 90 | 10 | 100 | 0.2 |
| PP3 | 80 | 20 | 100 | 0.2 |

Duplicate boards were made for each composition at each pressing pressure. The rate of effluent water produced from the piston press was recorded using the balance linked to a recording programme, for example, the RS COM programme available from RS components. RS COM is a commercial software used to record the data from mass balance into a file in the computer.

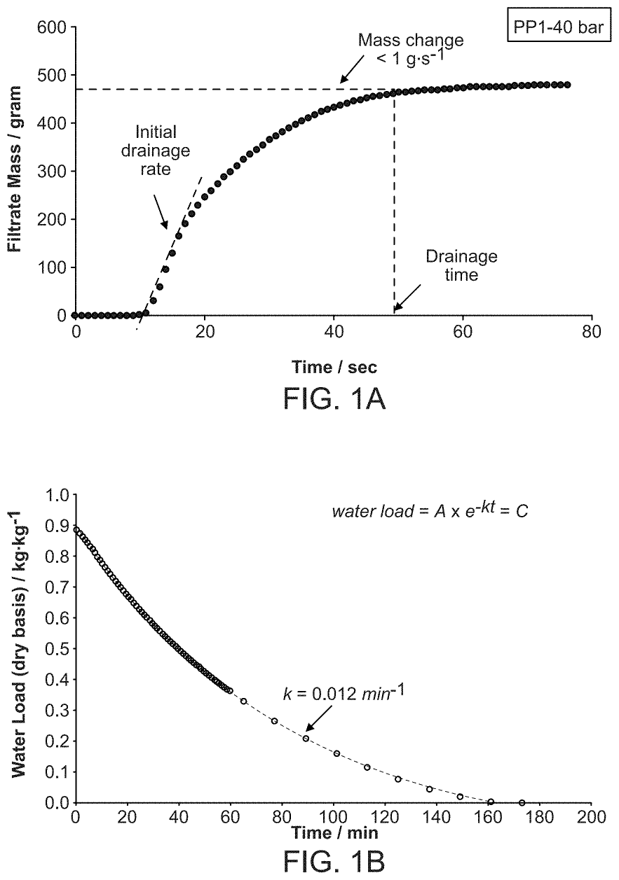

The initial drainage rate was determined by the initial slope gradient of a plot of mass against time for each board, and the drainage time was determined when the mass change became smaller than 1 g·s-1 (FIGS. 1A and 1B). The residence time of the wet board in the piston press was less than 5 min.

The wet boards were weighed on a balance to precision of 0.01 g. One of the duplicate boards made at each pressure was placed into a pre-heated oven at 130° C. overnight. The other board was dried on a moisture balance and the drying kinetics data collected was used to identify the rate of drying for each board (FIG. 1B).

Testing

Solid Content of the Pressed Boards

After collecting the wet pressed board from the piston press, the mass of the wet board (m_{wet}) was recorded before placing the wet board in the oven or moisture balance. The weight of the dry board (m_{dry}) was recorded after cooling down in a desiccator. The solid content of the wet board was calculated based on Equation 1.

$$Solid \% = 100 \times \frac{{m}_{dry}}{{m}_{wet}} \% \qquad Equation 1$$

Board Density

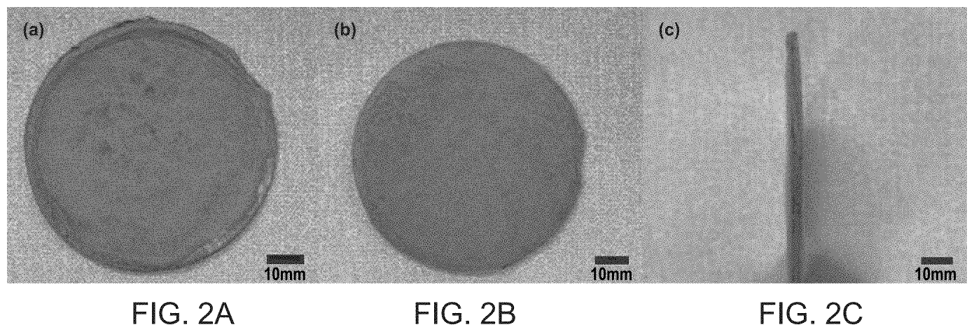

The mass of the dry board was obtained (above). The thickness of the board was measured by a digital caliper (h), and the result is an average of duplicate measurements. The board was assumed as a uniform round disc as illustrated in FIG. 2, with a diameter (D) of 7 cm. Therefore, the board density was calculated in g·cm⁻³ by Equation 2.

$$Board Density = \frac{{m}_{dry}}{h \times 3.14 \times {( D / 2 )}^{2}} \% \qquad Equation 2$$

FIGS. 2A-C present optical images of the piston pressed boards at 100 bar; the images are (FIG. 2A) filter cloth side, (FIG. 2B) piston side, and (FIG. 2C) cross section.

The flexural measurement was conducted on a Tinius Olsen H10KS Benchtop Tester. The support span was 64 mm and the test speed was 2 mm/min. The dried boards were cut into strips of 1.5 cm in width, and conditioned at 50% RH, 23° C. for 1 h before testing. The testing results were based on the duplicate measurement of each sample. The experiment was conducted at 50% RH, 23° C.

Modulus of elasticity (MOE) is the stiffness of a material, measuring an object's resistance to being deformed elastically when a stress is applied to it. Modulus of rupture (MOR, flexural strength) is the ultimate stress at failure in bending.

Water Uptake and Thickness Swelling Test

The boards were cut into 15 mm strips and the smallest piece from each board was used for the test. The initial mass (mᵤ) was recorded on a balance to a precision of ±0.01 g and thickness (h₀) was measured by a IP54 Digital Caliper to a precision of ±0.01 mm, then all the samples were placed into a large tray filled with distilled water at the same orientation, so that they were fully submerged. The specimens were only handled by the edges to reduce any damage. The specimens were taken out of the tray after 24 hours and placed onto a drying rack. The corresponding thickness (h₁) and mass (m₁) of the wet boards were recorded to calculate water uptake (Equation 3) and thickness swelling (Equation 4).

$$\begin{matrix}Water Uptake = 100 \times ( \frac{{m}_{1}}{{m}_{0}} - 1 ) \% & Equation 3 \\ Thickness Swelling = 100 \times ( \frac{{h}_{1}}{{h}_{0}} - 1 ) \% & Equation 4\end{matrix}$$

Results

Effect of Piston Pressure on Board Properties

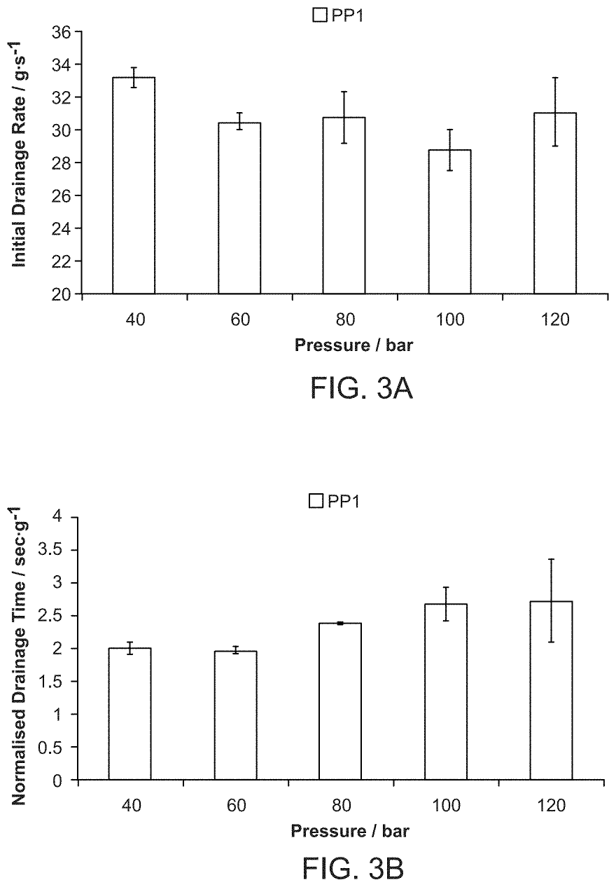

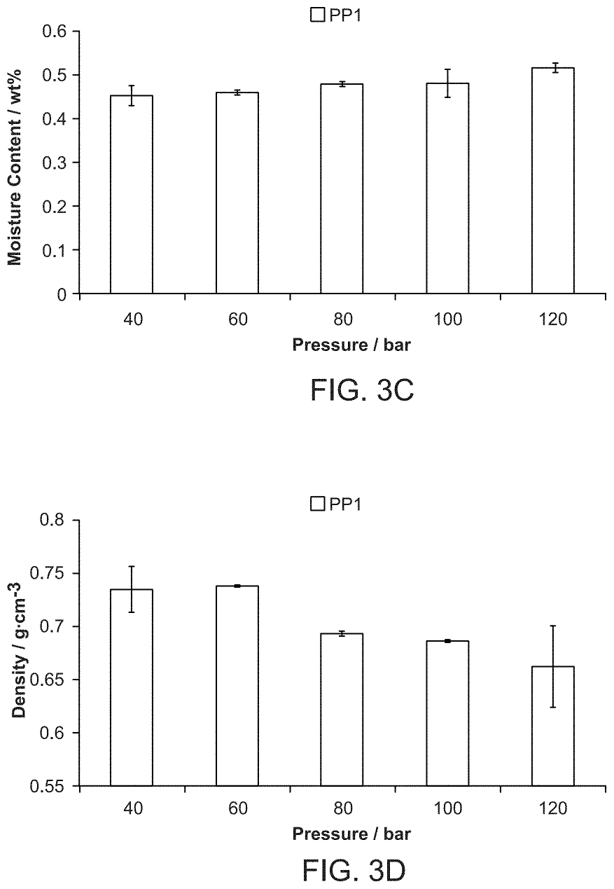

The initial study was carried out using 100 wt. % OCC to understand the effect of piston press pressure on the board formation and the corresponding properties. Several observations are made from FIG. 3.

The initial drainage rate was relatively constant over the whole pressure range—similar water channel structures formed in the beginning of the drainage process. (FIG. 3A)

The normalised drainage time increased with the increasing pressure—the bottom layer of the board become less permeable at higher pressure. (FIG. 3B)

The moisture content increased slightly at higher pressure—more water was held in the board due to less permeability of the bottom layer at higher pressure. (FIG. 3C)

Density of the dried board decreased with increasing pressure—as more water was removed at higher piston press, more voids created in the final board leading to lower density. (FIG. 3D).

Effect of Board Density on Bending Strength

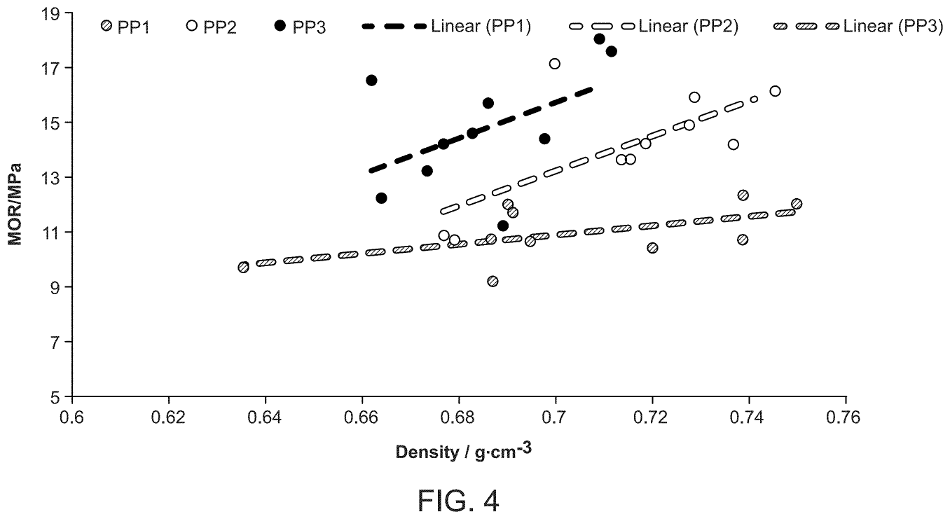

The MOR results of all the piston pressed boards are plotted against the corresponding board density, in order to (i) understand the correlation between MOR and density and (ii) compare the board strength with/without microfibrillated cellulose. Several observations are made from FIG. 4.

The MOR values increased with the increasing board density—the MOR data looked quite noisy with the linear fitting curves, which could be ascribed to the bad board formation.

The board density made from the piston press ranged from 0.66-0.75 g/cm⁻³ for all the 3 compositions—it was not clear that microfibrillated cellulose could improve board density in this study.

The addition of microfibrillated cellulose improved MOR significantly.

Effect of Microfibrillated Cellulose on Board Formation

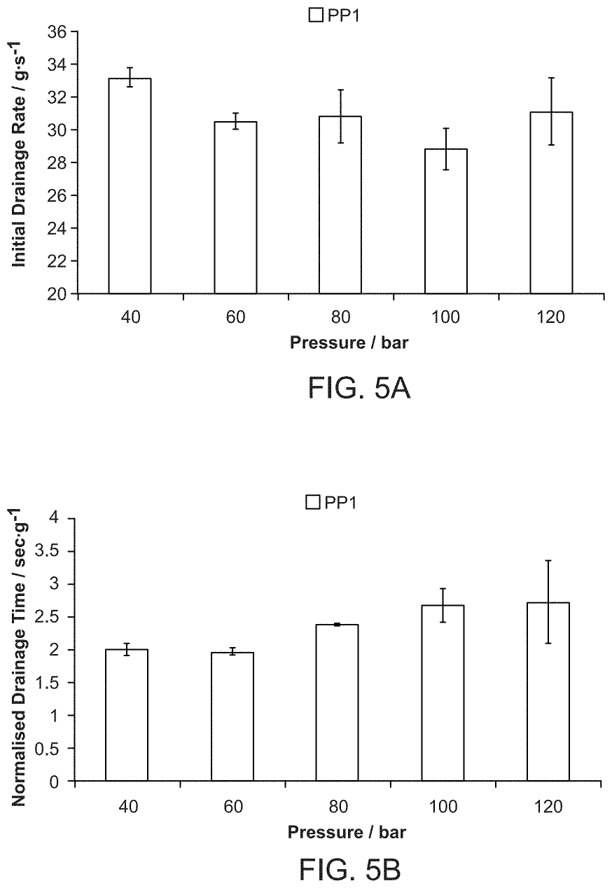

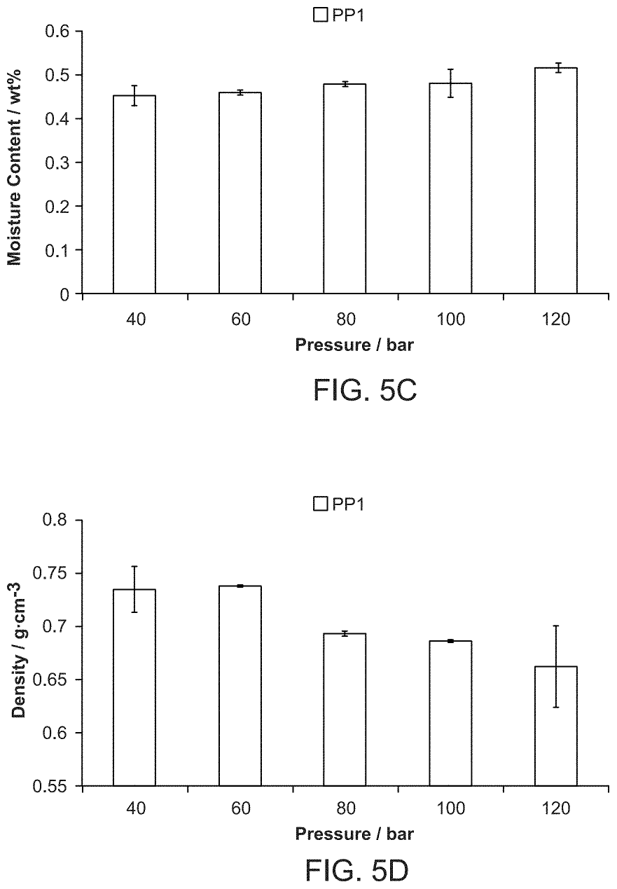

The addition of 50% POP microfibrillated cellulose was shown to have little impact on the board forming process (drainage and drying) in FIG. 5, if the dose of microfibrillated cellulose was below 10 wt. % (5 wt. % microfibrillated cellulose). Effect of microfibrillated cellulose dose is shown relative to initial drainage rate (FIG. 5A), normalised drainage time (FIG. 5B), moisture content (FIG. 5C) and drying rate constant (FIG. 5D).

Effect of Microfibrillated cellulose on Board Properties

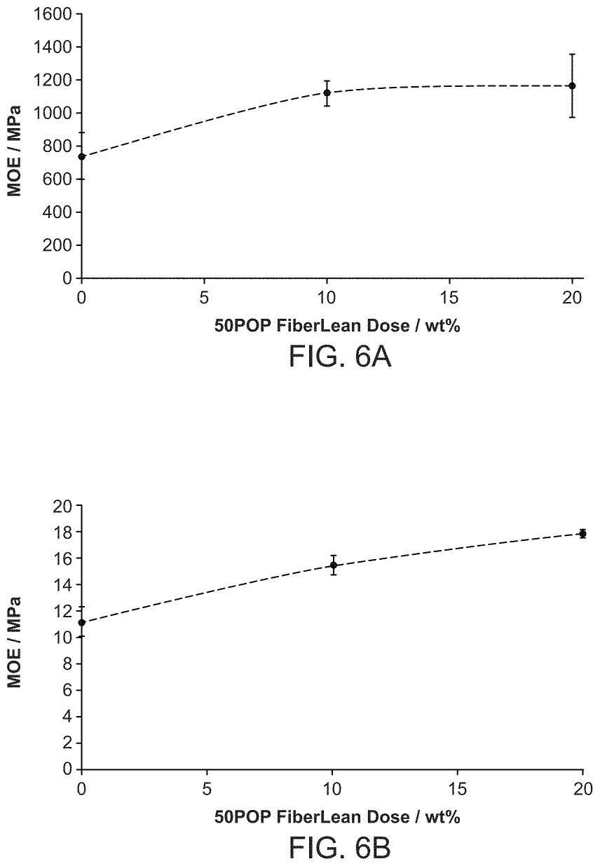

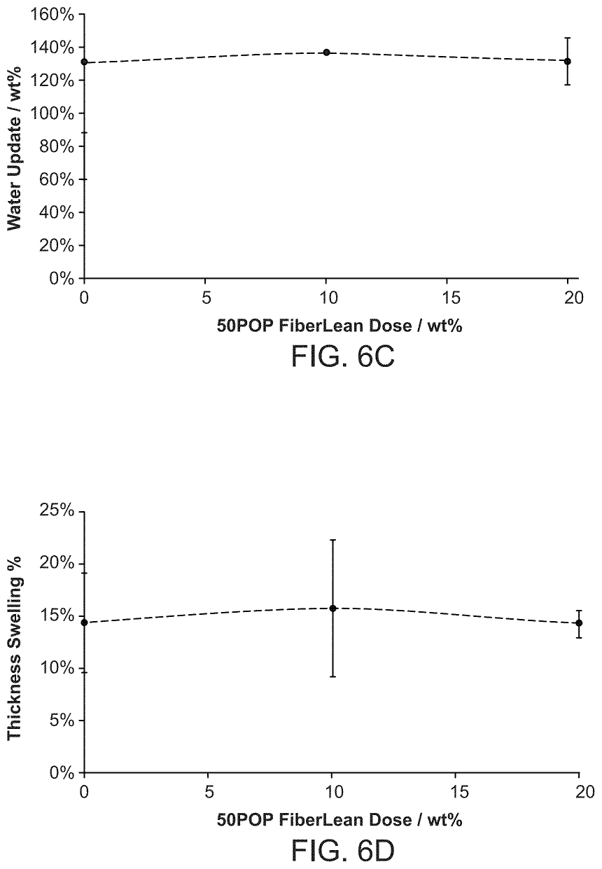

The addition of 50% POP FiberLean microfibrillated cellulose was shown to improve the mechanical performance of the boards gradually (FIG. 6A and FIG. 6B), but it had no impact on the water resistance of the boards (FIG. 6C and FIG. 6D). FIGS. 6A-D. Effect of microfibrillated cellulose dose on MOE (FIG. 6A), MOR (FIG. 6B), water uptake (FIG. 6C) and thickness swelling (FIG. 6D).

The result has proved the feasibility of producing boards containing MFC with improved board bending strength.

Results

The data for the experiments identified in Table 1 of Example 1 are reported below in Tables 2 to 4 below.

Effect of Board Density on Bending Strength

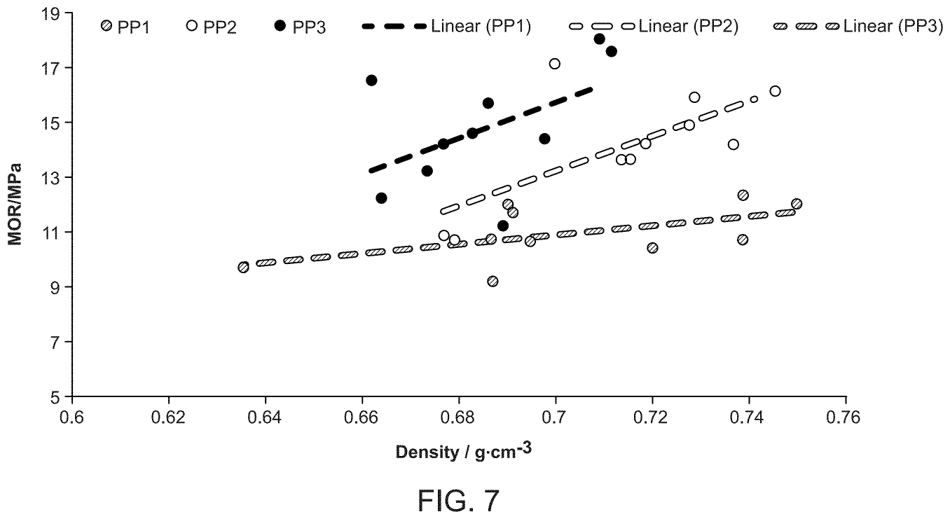

The MOR results of all the piston pressed boards are plotted against the corresponding board density, in order to (i) understand the correlation between MOR and density and (ii) compare the board strength with/without microfibrillated cellulose. Several observations are made from FIG. 7. FIG. 7 MOR vs. board density. The dash lines are linear fitting curves for visual guidance.

This study has proved the feasibility of producing small boards with reasonable thickness of at least 6 mm. The initial results demonstrated that microfibrillated cellulose could be used as an additive to improve board strength.

The MOR values increased with the increasing board density. The addition of microfibrillated cellulose improved MOR significantly.

Test boards manufactured from OCC are reported in Tables 2-4 below for the experiments identified in Table 1. Results for boards made with OCC and without microfibrillated cellulose are reported in Table 2 below. Results of test boards manufactured with OCC and 50% POP microfibrillated cellulose and clay at two dosages of 10 wt. % and 20 wt. % are shown in Tables 3 and 4 below.

TABLE 2

| Sample ID | | PP1-40 | PP1-60 | PP1-80 | PP1-100 | PP1-120 |
|---|---|---|---|---|---|---|
| OCC | wt. % | 100 | 100 | 100 | 100 | 100 |
| MFC/clay 50% POP | wt. % | 0 | 0 | 0 | 0 | 0 |
| Additional Filler | wt. % | 0 | 0 | 0 | 0 | 0 |
| Pressing Pressure | bar | 40 | 60 | 80 | 100 | 120 |
| Initial Drainage Rate | g · s⁻¹ | 33.2 | 30.5 | 30.8 | 28.8 | 31.1 |
| Normalised Drainage time | sec · g⁻¹ | 2.0 | 2.0 | 2.4 | 2.7 | 2.7 |
| | (dry cake) | | | | | |
| Moisture Content | wt. % | 45% | 46% | 48% | 48% | 52% |
| Drying Rate Constant | min⁻¹ | 0.0122 | 0.0123 | 0.0116 | 0.0117 | 0.0113 |
| Thickness | cm | 0.77 | 0.78 | 0.79 | 0.83 | 0.87 |
| Density | g · cm⁻³ | 0.73 | 0.74 | 0.69 | 0.69 | 0.66 |
| MOE | MPa | 740.5 | 783.2 | 666.5 | 657.9 | 711.0 |
| MOR | MPa | 11.2 | 11.5 | 11.2 | 9.9 | 10.8 |
| Water Uptake | wt. % | 132% | — | — | — | — |
| Thickness Swelling | % | 14% | — | — | — | — |

Test boards incorporating microfibrillated cellulose at 10 wt. % are reported in Table 3 below.

TABLE 3

| Sample ID | | PP2-40 | PP2-60 | PP2-80 | PP2-100 | PP2-120 |
|---|---|---|---|---|---|---|
| OCC | wt % | 90 | 90 | 90 | 90 | 90 |
| FiberLean | wt % | 10 | 10 | 10 | 10 | 10 |
| Additional Filler | wt % | 0 | 0 | 0 | 0 | 0 |
| Pressing Pressure | bar | 40 | 60 | 80 | 100 | 120 |
| Initial Drainage Rate | g · s⁻¹ | 36.2 | 35.2 | 36.9 | 36.8 | 34.6 |
| Normalised Drainage time | sec · g⁻¹ | 2.0 | 1.8 | 1.6 | 1.9 | 2.0 |
| | (dry cake) | | | | | |
| Moisture Content | wt % | 51% | 51% | 50% | 48% | 50% |
| Drying Rate Constant | min⁻¹ | 0.0110 | 0.0109 | 0.0118 | 0.0105 | 0.0105 |
| Thickness | cm | 0.70 | 0.78 | 0.81 | 0.76 | 0.80 |
| Density | g · cm⁻³ | 0.73 | 0.71 | 0.71 | 0.71 | 0.71 |
| MOE | MPa | 1115.7 | 802.8 | 624.5 | 958.8 | 900.6 |
| MOR | MPa | 15.4 | 13.6 | 12.5 | 15.7 | 13.4 |
| Water Uptake | wt % | 138% | — | — | — | — |
| Thickness Swelling | % | 16% | — | — | — | — |

Test boards incorporating microfibrillated cellulose at 20 wt. % are reported in Table 4 below.

| Sample ID | | PP3-40 | PP3-60 | PP3-80 | PP3-100 | PP3-120 |
|---|---|---|---|---|---|---|
| OCC | wt % | 80 | 80 | 80 | 80 | 80 |
| MFC/clay 50% POP | wt % | 20 | 20 | 20 | 20 | 20 |
| Additional Filler | wt % | 0 | 0 | 0 | 0 | 0 |
| Pressing Pressure | bar | 40 | 60 | 80 | 100 | 120 |
| Initial Drainage Rate | g · s⁻¹ | 29.5 | 27.8 | 31.2 | 35.2 | 37.9 |
| Normalised Drainage time | sec · g⁻¹ | 3.2 | 2.8 | 2.7 | 2.1 | 2.1 |
| | (dry cake) | | | | | |
| Moisture Content | wt % | 52% | 53% | 55% | 55% | 53% |
| Drying Rate Constant | min⁻¹ | 0.0093 | 0.0100 | 0.0100 | 0.0094 | 0.0088 |
| Thickness | cm | 0.77 | 0.79 | 0.78 | 0.83 | 0.87 |
| Density | g · cm⁻³ | 0.71 | 0.69 | 0.67 | 0.68 | 0.68 |
| MOE | MPa | 1161.4 | 844.3 | 953.3 | 814.5 | 629.1 |
| MOR | MPa | 17.8 | 14.5 | 16.1 | 13.7 | 11.7 |
| Water Uptake | wt % | 133% | — | — | — | — |
| Thickness Swelling | % | 14% | — | — | — | — |

Example 2 was performed in accordance with the procedure of Example 1. The data for Example 2 is reported below in Table 5.

TABLE 5

| | | MFC/clay | Additional | Pressing | | | | |
|---|---|---|---|---|---|---|---|---|
| Sample | OCC | 50% POP | Filler | Pressure | Thickness | Density | MOE | MOR |
| ID | wt. % | wt. % | wt. % | bar | cm | g · cm⁻³ | MPa | MPa |
| PP1-40 | 100 | 0 | 0 | 40 | 0.77 | 0.73 | 740.5 | 11.2 |
| PP1-60 | 100 | 0 | 0 | 60 | 0.78 | 0.74 | 783.2 | 11.5 |
| PP1-80 | 100 | 0 | 0 | 80 | 0.79 | 0.69 | 666.5 | 11.2 |
| PP1-100 | 100 | 0 | 0 | 100 | 0.83 | 0.69 | 657.9 | 9.9 |
| PP1-120 | 100 | 0 | 0 | 120 | 0.87 | 0.66 | 711.0 | 10.8 |
| PP2-40 | 90 | 10 | 0 | 40 | 0.70 | 0.73 | 1115.7 | 15.4 |
| PP2-60 | 90 | 10 | 0 | 60 | 0.78 | 0.71 | 802.8 | 13.6 |
| PP2-80 | 90 | 10 | 0 | 80 | 0.81 | 0.71 | 624.5 | 12.5 |
| PP2-100 | 90 | 10 | 0 | 100 | 0.76 | 0.71 | 958.8 | 15.7 |
| PP2-120 | 90 | 10 | 0 | 120 | 0.80 | 0.71 | 900.6 | 13.4 |
| PP3-40 | 80 | 20 | 0 | 40 | 0.77 | 0.71 | 1161.4 | 17.8 |
| PP3-60 | 80 | 20 | 0 | 60 | 0.79 | 0.69 | 844.3 | 14.5 |
| PP3-80 | 80 | 20 | 0 | 80 | 0.78 | 0.67 | 953.3 | 16.1 |
| PP3-100 | 80 | 20 | 0 | 100 | 0.83 | 0.68 | 814.5 | 13.7 |
| PP3-120 | 80 | 20 | 0 | 120 | 0.87 | 0.68 | 629.1 | 11.7 |

### Example 3

Example 3 was performed in accordance with the materials and procedures of Example 1, except that microfibrillated cellulose was prepared from recycled pulp, according to the procedures set forth below.

The optimum grinding parameters (4% total solids, 50% POP, 42% MVC, 50 kW/m3) were established through running a series of calibration grinds using a supermill (pilot stirred media detritor (SMD) grinder) with a charge of 155 kg of 3 Mullite media. The production process for the various calibration grinds involved co-grinding old corrugated cardboard pulp with ND1500 (clay filler), targeting 50% POP, with the variables being the media volume concentration, the total solids' percentage and the specific energy input.

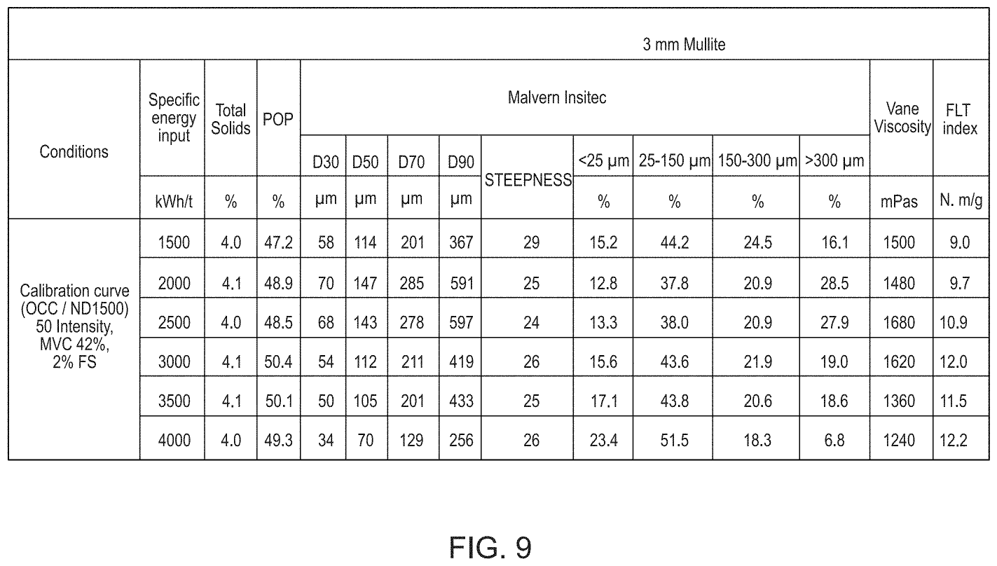

A summary of the production conditions and laboratory testing results for sample is listed in FIG. 9.

Old Corrugated Cardboard (OCC) (Product Code DSB205618, DS Smith) was refined for 20 minutes in 12 litres of 5 wt. % consistency in a large disintegrator. The binder composition comprised 50% percentage of pulp (POP) of Intramax™ 57 (IMAX57) available from Imerys Minerals Limited) and microfibrillated cellulose manufactured from recycled pulp in accordance with the grinding procedures set forth in the specification. IMAX 57 is a paper filler grade kaolin. The binder composition was centrifuged at 4600 rpm for 30 minutes, and the total solid of the centrifuged binder composition was measured by moisture balance. A 0.1 wt. % anionic organic polymer retention aid (PERFORM PC930 available from Solenis, Wilmington, Del., USA) composition was prepared with distilled water using a rotating impeller.

The composition of the board slurry included the refined OCC pulp and OCC pulp and microfibrillated cellulose manufactured from recycled pulp. The resultant slurry at 4 wt. % consistency was mixed with a flocculant (0.2 wt. % dose of anionic organic polymer retention aid (PERFORM PC930) on dried board mass, and then poured into a piston press with a total volume of 550 ml. Five pressure conditions were used to produce the boards: 40 bar, 60 bar, 80 bar, 100 bar and 120 bar.

Microfibrillated cellulose manufactured from recycled pulp, OCC and additive were loaded into a piston cylinder and compacted by a pneumatic piston against a drainage gauze at the other end. The disk so formed was extracted, dried and tested. The rate at which water drains out of the device was a function of the applied pressure and is an important parameter as this impacts production rate and drying costs. The MFC and OCC boards were compared to a board manufactured using a comparable procedure except the board contained only OCC.

Results

Boards made from OCC and microfibrillated cellulose manufactured from recycled pulp demonstrated reduced thickness, increased density, and a substantial improvement in MOE and MOR compared to a control board manufactured using the same procedures, but without the addition of microfibrillated cellulose. The results are presented in Table 6 below.

TABLE 6

| | | | Addi- | | | | |
|---|---|---|---|---|---|---|---|
| | | MFC/clay | tional | Thick- | Den- | | |
| Exam- | OCC | 50% POP | Filler | ness | sity | MOE | MOR |
| ple | wt. % | wt. % | wt. % | cm | g · cm⁻³ | MPa | MPa |
| Control | 100 | 0 | 0 | 0.78 | 0.72 | 499.6 | 8.3 |
| MFC | 90 | 10 | 0 | 0.62 | 0.84 | 1010.3 | 17.8 |
| board | | | | | | | |

### Example 4

Boards were manufactured in accordance with Example 2 however utilizing a mixture of 90 wt. % OCC and 10 wt. % office paper, as well as microfibrillated cellulose manufactured from recycled pulp (50% POP; filler was ND1500 kaolin clay (Imerys, U.K.)) at a dosage of 10 wt. %. The MFC and OCC boards were compared to a board manufactured using a comparable procedure except the board contained only OCC.

Results

The boards demonstrated comparable thickness, increased density and substantially increased MOE and MOR compared to the control boards manufactured using a comparable procedure without microfibrillated cellulose manufactured from recycled pulp.

The results of Example 4 are presented in Table 7 below.

TABLE 7

| | | | Addi- | | | | |
|---|---|---|---|---|---|---|---|
| | | MFC/clay | tional | Thick- | Den- | | |
| Exam- | OCC | 50% POP | Filler | ness | sity | MOE | MOR |
| ple | wt. % | wt. % | wt. % | cm | g · cm⁻³ | MPa | MPa |
| Control | 100 | 0 | 0 | 0.62 | 0.86 | 934.0 | 11.0 |
| MFC | 90 | 10 | 0 | 0.63 | 0.89 | 1007.9 | 12.2 |
| board | | | | | | | |

### Example 5

Boards were manufactured from 90 wt. % OCC manufactured using a pulper and 10 wt. % microfibrillated cellulose manufactured from recycled pulp (50% POP; filler was ND1500 kaolin clay (Imerys, U.K.)) in accordance with Example 2. The MFC and OCC boards were compared to a board manufactured using a comparable procedure except the board contained only OCC.

Results

The boards demonstrated increased thickness, increased density and substantially increased MOE and MOR compared to the control boards manufactured using a comparable procedure without microfibrillated cellulose manufactured from recycled pulp.

The results of Example 4 are presented in Table 8 below.

TABLE 8

| | | | Addi- | | | | |
|---|---|---|---|---|---|---|---|
| | | MFC/clay | tional | Thick- | Den- | | |
| Exam- | OCC | 50% POP | Filler | ness | sity | MOE | MOR |
| ple | wt. % | wt. % | wt. % | cm | g · cm⁻³ | MPa | MPa |
| Control | 100 | 0 | 0 | 0.54 | 0.75 | 1130.4 | 11.4 |
| MFC | 90 | 10 | 0 | 0.70 | 0.78 | 1269.1 | 16.7 |
| board | | | | | | | |

### Example 6

Boards were manufactured from 90 wt. % OCC manufactured using a disc refiner at 3 wt. % consistency and 10 wt. % microfibrillated cellulose manufactured from recycled pulp (50% POP; filler was ND1500 kaolin clay (Imerys, U.K.) in accordance with Example 2. The MFC and OCC boards were compared to a board manufactured using a comparable procedure except the board contained only OCC.

Results

The boards demonstrated increased thickness, decreased density and substantially increased MOR compared to the control boards manufactured using a comparable procedure without microfibrillated cellulose manufactured from recycled pulp.

The results of Example 6 are presented in Table 9 below.

TABLE 9

| | | | Addi- | | | | |
|---|---|---|---|---|---|---|---|
| | | MFC/clay | tional | Thick- | Den- | | |
| Exam- | OCC | 50% POP | Filler | ness | sity | MOE | MOR |
| ple | wt. % | wt. % | wt. % | cm | g · cm⁻³ | MPa | MPa |
| Control | 100 | 0 | 0 | 0.63 | 0.89 | — | 8.2 |
| MFC | 90 | 10 | 0 | 0.76 | 0.73 | — | 13.4 |
| board | | | | | | | |

In Example 7, the degree of refining the recycled pulp was determined via a Canadian Standard Freeness (CSF) measurement (TAPPI Test Method T 227 om-17). A collected sample was diluted to 0.3 wt. % consistency and temperature was recorded, then 1 litre of the dilution was passed through the CSF tester. The volume of water drained from the side outlet corresponds to the CSF value in ml, and the measured value was then corrected according to the temperature. The freeness of the recycled pulp is reported in Table 10 below.

TABLE 10

| | CSF |
|---|---|
| Example | ml |
| OCC from disintegrator | 455 |
| OCC from pulper | 313 |
| OCC from disc refiner | 325 |
| OCC from deflaker | 322 |

### Example 8

Boards were made from OCC produced using a deflaker. The test boards contained 82 wt. % OCC made using a deflaker and 18 wt. % of microfibrillated cellulose manufactured from recycled pulp at 33% percentage of pulp (POP); filler was IC60 calcium carbonate from Imerys Minerals Limited (U.K.). The mineral employed in the co-processing of microfibrillated cellulose was calcium carbonate (IC60) at a level of 67 wt. %. The MFC and OCC boards were compared to a board manufactured using a comparable procedure except the board contained only OCC.

Results

Boards manufactured from OCC and microfibrillated cellulose at 33 wt. % of pulp in accordance with Example 2 demonstrated increases thickness and density as well as substantially increased MOR and MOE. The results of the testing are presented in Table 11 below.

TABLE 11

| | | | Addi- | | | | |
|---|---|---|---|---|---|---|---|
| | | MFC/clay | tional | Thick- | Den- | | |
| Exam- | OCC | 50% POP | Filler | ness | sity | MOE | MOR |
| ple | wt. % | wt. % | wt. % | cm | g · cm⁻³ | MPa | MPa |
| Control | 100 | 0 | 0 | 0.16 | 0.56 | 448.5 | 7.7 |
| MFC | 82 | 18 | 0 | 0.41 | 0.90 | 725.9 | 13.7 |
| board | | | | | | | |

### Example 9

Boards were made from 20 wt. % percentage of pulp microfibrillated cellulose and microfibrillated cellulose manufactured from recycled pulp (20% POP filler was ND1500 kaolin clay from Imerys U.K.) in accordance with Example 3. The MFC and OCC boards were compared to a board manufactured using a comparable procedure except the board contained only OCC.

Results

The boards demonstrated comparable thickness and density. However, the boards showed substantial increases in MOE and MOR. The results of Example 9 are presented in Table 12 below.

TABLE 12

| | | | Addi- | | | | |
|---|---|---|---|---|---|---|---|
| | | MFC/clay | tional | Thick- | Den- | | |
| Exam- | OCC | 50% POP | Filler | ness | sity | MOE | MOR |
| ple | wt. % | wt. % | wt. % | cm | g · cm⁻³ | MPa | MPa |
| Control | 100 | 0 | 0 | 0.78 | 0.72 | 499.6 | 8.3 |
| 20% POP | 90 | 10 | 0 | 0.74 | 0.82 | 1209.9 | 9.8 |
| MFC | | | | | | | |

### Example 10

Boards were manufactured in accordance with the procedures of Example 2 using OCC and microfibrillated cellulose prepared from recycled pulp (50% POP, filler ND1500 clay from Imerys UK) and additional filler consisting of 50 wt. % Snowcal 60 ground calcium carbonate and 50 wt. % PCC-S. The MFC and OCC boards were compared to a board manufactured using a comparable procedure except the board contained only OCC.

Results

The boards demonstrated reduced thickness, increased density and substantially increased MOE and MOR values. The results are presented in Table 13 below.

TABLE 13

| | | | Addi- | | | | |
|---|---|---|---|---|---|---|---|
| | | MFC/clay | tional | Thick- | Den- | | |
| Exam- | OCC | 50% POP | Filler | ness | sity | MOE | MOR |
| ple | wt. % | wt. % | wt. % | cm | g · cm⁻³ | MPa | MPa |
| Control | 100 | 0 | 0 | 0.78 | 0.72 | 499.6 | 8.3 |
| Board with | 90 | 5 | 5 | 0.66 | 0.84 | 941.1 | 12.4 |
| PCC/GCC | | | | | | | |

### Example 11

OCC boards were manufactured with minerals indicated in Table 14 with and without microfibrillated cellulose manufactured from recycled pulp (50% POP, filler ND1500 clay from Imerys U.K.) in accordance with Example 2. Additional filler was used corresponding to the mineral type used in accordance with Table 14. The minerals utilized included aluminum trihydrate (ATH), bentonite, talc (Luzenac, Imerys France), mica, precipitated calcium carbonate, perlite, metakaolin, calcined kaolin, ball clay, magnesium hydroxide, magnesium carbonate, diatomaceous earth, dolomite and halloysite. The MFC and OCC boards were compared to a board manufactured using a comparable procedure except the board contained only OCC.

Results

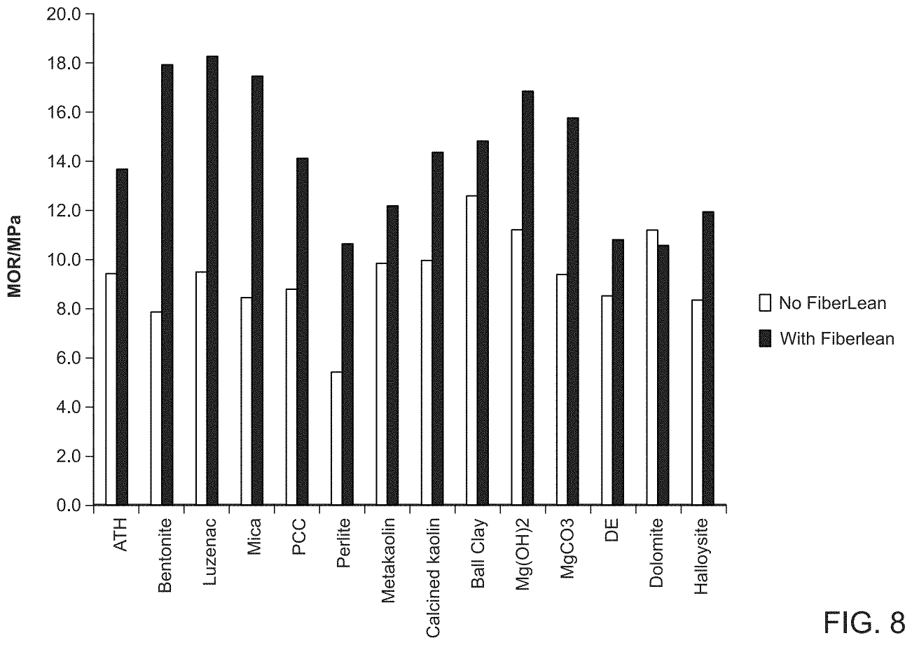

With the exception of dolomite and halloysite the boards contain the specified mineral and microfibrillated cellulose exhibited substantial increases in both MOE and MOR. In the case of dolomite the MOE was comparable to the control boards without microfibrillated cellulose, whereas the MOE was substantially increased for boards utilizing halloysite and microfibrillated cellulose. The result demonstrates the viability of utilizing MFC to improve the mechanical performance (MOE/MOR) of the boards containing various minerals. The results appear in Table 14 below and in FIG. 8.

TABLE 14

| | | MFC/clay | Add. | | | | |
|---|---|---|---|---|---|---|---|
| | OCC | 50% POP | Filler | Thickness | Density | MOE | MOR |
| Example | wt. % | wt. % | wt. % | cm | g · cm⁻³ | MPa | MPa |
| Control | 100 | 0 | 0 | 0.78 | 0.72 | 499.6 | 8.3 |
| ATH | 95 | 0 | 5 | 0.75 | 0.76 | 359.9 | 9.3 |
| ATH + MFC | 90 | 5 | 5 | 0.65 | 0.81 | 1345.2 | 13.6 |
| Bentonite | 95 | 0 | 5 | 0.76 | 0.75 | 926.1 | 7.8 |
| Bentonite + MFC | 90 | 5 | 5 | 0.62 | 0.84 | 1196.3 | 18.0 |
| Luzenac | 95 | 0 | 5 | 0.73 | 0.77 | 480.2 | 9.5 |
| Luzenac + MFC | 90 | 5 | 5 | 0.61 | 0.83 | 976.5 | 18.3 |
| Mica | 95 | 0 | 5 | 0.73 | 0.75 | 209.0 | 8.5 |
| Mica + MFC | 90 | 5 | 5 | 0.59 | 0.86 | 646.9 | 17.4 |
| PCC | 95 | 0 | 5 | 0.74 | 0.75 | 68.9 | 8.8 |
| PCC + MFC | 90 | 5 | 5 | 0.65 | 0.80 | 1250.4 | 14.1 |
| Perlite | 95 | 0 | 5 | 0.78 | 0.73 | 181.0 | 5.3 |
| Perlite + MFC | 90 | 5 | 5 | 0.69 | 0.75 | 1071.7 | 10.6 |
| Metakaolin | 95 | 0 | 5 | 0.74 | 0.76 | 155.3 | 9.8 |
| Metakaolin + MFC | 90 | 5 | 5 | 0.72 | 0.77 | 1404.3 | 12.2 |
| Calcined kaolin | 95 | 0 | 5 | 0.71 | 0.80 | 215.6 | 9.9 |
| calcined kaolin + | 90 | 5 | 5 | 0.66 | 0.82 | 945.3 | 14.4 |
| MFC | | | | | | | |
| Ball Clay | 95 | 0 | 5 | 0.54 | 0.81 | 228.8 | 12.6 |
| Ball Clay + MFC | 90 | 5 | 5 | 0.64 | 0.84 | 1138.0 | 14.8 |
| Mg(OH)2 | 95 | 0 | 5 | 0.70 | 0.80 | 816.0 | 11.2 |
| Mg(OH)2 + MFC | 90 | 5 | 5 | 0.64 | 0.82 | 1247.6 | 16.9 |
| MgCO3 | 95 | 0 | 5 | 0.72 | 0.77 | 1109.8 | 9.4 |
| MgCO3 + MFC | 90 | 5 | 5 | 0.66 | 0.81 | 1210.0 | 15.8 |
| diatomaceous earth | 95 | 0 | 5 | 0.76 | 0.76 | 906.0 | 8.4 |
| diatomaceous earth + | 90 | 5 | 5 | 0.72 | 0.76 | 675.1 | 10.8 |
| MFC | | | | | | | |
| Dolomite | 95 | 0 | 5 | 0.75 | 0.78 | 1102.9 | 11.2 |
| Dolomite + MFC | 90 | 5 | 5 | 0.73 | 0.78 | 612.0 | 10.6 |
| Halloysite | 95 | 0 | 5 | 0.74 | 0.78 | 1341.5 | 8.3 |
| Halloysite + MFC | 90 | 5 | 5 | 0.68 | 0.79 | 647.7 | 11.9 |

### Example 12

Boards were prepared from 90 wt. % OCC and 5 wt. % microfibrillated cellulose prepared from bleached softwood kraft virgin pulp (50% POP, filler IC 60 calcium carbonate from Imerys Minerals Limited (U.K.) and 5 wt. % additional filler consisting of ground calcium carbonate (IC60) from Imerys Minerals Limited (U.K.). The MFC and OCC boards were compared to a board manufactured using a comparable procedure except the board contained only OCC.

Results

The boards demonstrated comparable thickness and density to the control board, whereas the boards containing microfibrillated cellulose showed a substantial increase in MOE and MOR. Results are presented in Table 15 below.

TABLE 15

| | | | Addi- | | | | |
|---|---|---|---|---|---|---|---|
| | | MFC/clay | tional | Thick- | Den- | | |
| Exam- | OCC | 50% POP | Filler | ness | sity | MOE | MOR |
| ple | wt. % | wt. % | wt. % | cm | g · cm⁻³ | MPa | MPa |
| Control | 100 | 0 | 0 | 0.78 | 0.72 | 499.6 | 8.3 |
| MFC | 90 | 5 | 5 | 0.79 | 0.72 | 675.1 | 9.7 |
| board | | | | | | | |

Example 13

Boards comprising OCC at levels of 70 wt. %, 80 wt. %, 90 wt. % and 100 wt. % were prepared with dosages of microfibrillated cellulose prepared from recycled pulp (50% POP, filler ND1500 kaolin clay from Imerys UK) at levels of 5 wt. %, 10 wt. % and 15 wt. %. The MFC and OCC boards were compared to a board manufactured using a comparable procedure except the board contained only OCC.

Results

The OCC boards made with microfibrillated cellulose had a lower thickness, but increased density compared to the control boards of 100 wt. % OCC without microfibrillated cellulose. However, the microfibrillated cellulose containing boards demonstrated a substantial increase in MOE and MOR. The results appear below in Table 16.

TABLE 16

| | | MFC/clay | Additional | | | | |
|---|---|---|---|---|---|---|---|
| | OCC | 50% POP | Filler | Thickness | Density | MOE | MOR |
| Example | wt. % | wt. % | wt. % | cm | g · cm⁻³ | MPa | MPa |
| Control | 100 | 0 | 0 | 0.78 | 0.72 | 499.6 | 8.3 |
| 5 wt. % microfibrillated | 90 | 10 | 0 | 0.69 | 0.79 | 1055.9 | 12.0 |
| cellulose | | | | | | | |
| 10 wt. % microfibrillated | 80 | 20 | 0 | 0.70 | 0.78 | 1112.9 | 13.3 |
| cellulose | | | | | | | |
| 15 wt. % microfibrillated | 70 | 30 | 0 | 0.61 | 0.84 | 1311.5 | 13.6 |
| cellulose | | | | | | | |

### Example 14

Low density boards were made without pressing with 90 wt. % OCC, 5 wt. % microfibrillated cellulose from recycled pulp (50% POP, filler: ND1500 clay from Imerys UK) manufactured in accordance with the procedures of Example 2 and 5 wt. % additional filler consisting of ND1500 kaolin clay from Imerys Minerals Limited (U.K.). The low density OCC board was compared to a board comprising 90 wt. % OCC, 5 wt. % microfibrillated cellulose from recycled pulp manufactured in accordance with the procedures of Example 2 and 5 wt. % additional filler consisting of ND1500 kaolin clay pressed at 40 bar.

Results

The result show that substantial increases in MOE and MOR are realized upon pressing the boards. The results also show that a board of low density can be prepared, which could be used in an application such as a light weight material insulator. Results are reported in Table 17 below.

TABLE 17

| | | | Addi- | | | | |
|---|---|---|---|---|---|---|---|
| | | MFC/clay | tional | Thick- | Den- | | |
| Exam- | OCC | 50% POP | Filler | ness | sity | MOE | MOR |
| ple | wt. % | wt. % | wt. % | cm | g · cm⁻³ | MPa | MPa |
| MFC board pressed | 90 | 5 | 5 | 0.72 | 0.77 | 499.6 | 12.2 |
| at 40 bar | | | | | | | |
| MFC board pressed | 90 | 5 | 5 | 0.93 | 0.23 | 240.5 | 2.0 |
| without pressing - | | | | | | | |
| low density insulator | | | | | | | |

### Example 15

90 wt. % OCC boards comprising 5 wt. % microfibrillated cellulose from recycled pulp (50% POP, filler: ND1500 clay from Imerys U.K.) with either dispersing aids of non-ionic polyoxyethylene from Sigma Aldrich diluted to 1% solids, or anionic polyacrylamide (Kemira Oy) diluted to 1% solids, and additional filler consisting of ND1500 kaolin clay from Imerys were manufactured. A formation aid was dosed at 0.1 wt. % based on dry board mass. The control board consisted of 100 wt. % OCC with no formation aid.

Results

The experimental boards demonstrated less thickness and greater density than the control 100 wt. % OCC boards. Both experimental boards showed substantial increases in MOE and MOR compared to the OCC control board. The results are reported below in Table 18.

TABLE 18

| | | MFC/clay | Addn. | | | | |
|---|---|---|---|---|---|---|---|
| | OCC | 50% POP | Filler | Thickness | Density | MOE | MOR |
| Example | wt. % | wt. % | wt. % | cm | g · cm⁻³ | MPa | MPa |
| Control with no | 100 | 0 | 0 | 0.78 | 0.72 | 499.6 | 8.3 |
| formation aid | | | | | | | |
| MFC board with | 90 | 5 | 5 | 0.75 | 0.74 | 594.2 | 9.8 |
| Polyethylene Oxide | | | | | | | |
| MFC board with Kemira | 90 | 5 | 5 | 0.70 | 0.79 | 1061.1 | 12.9 |
| Fennosil ™ | | | | | | | |

### Example 16

Boards comprising 90 wt. % OCC and 10 wt. % microfibrillated cellulose from recycled pulp (50% POP, filler: ND1500 clay from Imerys U.K.) were compared to control boards consisting of 100 wt. % OCC. The microfibrillated cellulose was prepared from recycled pulp in accordance with the procedures of Example 4. A sizing agent Aquapel™ F315, 16 wt. % solids (Solenis) was added at a level of 0.5 wt. % on dry board mass.

Results

The experimental boards were less thick but of greater density. The experimental boards demonstrated substantial increases in MOE and MOR values. The experimental boards demonstrated less water uptake ad substantially less swelling than the control boards. The results are reported below in Table 19.

TABLE 19

| | | MFC/clay | Additional | | | | | Water | thickness |
|---|---|---|---|---|---|---|---|---|---|
| | OCC | 50% POP | Filler | Thickness | Density | MOE | MOR | Uptake | swelling |
| Example | wt. % | wt. % | wt. % | cm | g · cm⁻³ | MPa | MPa | % | % |
| Control | 100 | 0 | 0 | 0.78 | 0.72 | 499.6 | 8.3 | 159.7 | 31.55 |
| MFC | 90 | 10 | 0 | 0.7 | 0.85 | 1084.4 | 14 | 52.5 | 13.6 |
| board | | | | | | | | | |
| with AKD | | | | | | | | | |
| sizing | | | | | | | | | |

### Example 17

Fibre steepness of microfibrillated cellulose manufactured in accordance with Example 4 from bleached softwood kraft pulp virgin pulp (50% POP, filler: ND1500 clay from Imerys U.K.) and recycled pulp (50% POP, filler: ND1500 clay from Imerys U.K.) are reported in Table 20 below. Also reported are d₃₀, d₅₀, d₇₀ and d₉₀ values for the microfibrillated cellulose.

TABLE 20

| | Particle Size Distribution | | | | |
|---|---|---|---|---|---|
| | by Laser Diffraction | | | | |
| | D30 | D50 | D70 | D90 | |
| Example | μm | μm | μm | μm | Steepness |
| microfibrillated cellulose | 99 | 202 | 379 | 808 | 26 |
| from virgin pulp | | | | | |
| microfibrillated cellulose | 68 | 143 | 278 | 597 | 24 |
| from recycled pulp | | | | | |

### Example 18

Laminates of two board were prepared in this Example. The multilayered boards were prepared from 90 wt. % OCC, 5 wt. % microfibrillated cellulose prepared from recycled pulp (50% POP, filler: ND1500 clay from Imerys U.K.) in accordance with Example 2 and 5 wt. % additional filler consisting of ND1500 kaolin clay from Imerys. The experimental boards were compared to boards made of 100 wt. % OCC.

Results

The experimental multilayer boards showed a reduced thickness and density, and a substantial increase in MOE and MOR values. The data is reported below in Table 21.

TABLE 21

| | | | Addi- | | | | |
|---|---|---|---|---|---|---|---|
| | | MFC/clay | tional | Thick- | Den- | | |
| Exam- | OCC | 50% POP | Filler | ness | sity | MOE | MOR |
| ple | wt. % | wt. % | wt. % | cm | g · cm⁻³ | MPa | MPa |
| Control | 100 | 0 | 0 | 0.78 | 0.72 | 499.6 | 8.3 |
| Multi- | 90 | 5 | 5 | 0.65 | 0.60 | 1322.4 | 13.3 |
| layered | | | | | | | |
| Board | | | | | | | |

### Example 19

Boards prepared from 80 wt. % OCC, 10 wt. % microfibrillated cellulose prepared from recycled pulp (50% POP, filler: ND1500 clay from Imerys U.K.) in accordance with the procedures of Example 2, 5 wt. % additional filler consisting of kaolin and 5 wt. % native starch were compared to control boards comprising either 100 wt. % OCC or 80 wt. % OCC, 10 wt. % kaolin filler and 10 wt. % native starch. The experimental boards showed comparable thickness and density to the control boards comprising additional filler and native starch, but reduced thickness and increased density compared to the control boards made from 100 wt. % OCC. Substantial increases in MOE and MOR values were shown compared to both control boards. Results are reported in Table 22 below.

TABLE 22

| | | MFC/clay | Additional | Native | | | | |
|---|---|---|---|---|---|---|---|---|
| | OCC | 50% POP | Filler | Starch | Thickness | Density | MOE | MOR |
| Example | wt. % | wt. % | wt. % | wt. % | cm | g · cm⁻³ | MPa | MPa |
| Control- | 100 | 0 | 0 | 0 | 0.78 | 0.72 | 499.6 | 8.3 |
| 1 | | | | | | | | |
| control- | 80 | 0 | 10 | 10 | 0.65 | 0.83 | 1199.0 | 19.8 |
| 2 | | | | | | | | |
| MFC | 80 | 10 | 5 | 5 | 0.67 | 0.83 | 1557.1 | 22.4 |
| with | | | | | | | | |
| starch | | | | | | | | |

### Example 20

Boards made from 90 wt. % OCC and 10 wt. % microfibrillated cellulose manufactured from recycled pulp (50% POP, filler: ND1500 clay from Imerys U.K.) in accordance with the procedures of Example 2 and rosin and aklum diluted together to 30% solids in a 1:1 ratio were compared against control boards manufactured from 100 wt. % OCC. The dose of the rosin and alum mixture was 2.6 wt. % on dry board mass.

Results

The experimental boards demonstrated reduced thickness and increased density compared to the control boards made without sizing. The experimental boards demonstrated substantial increases in MOE and MOR values compared to the experimental boards. The results are shown below in Table 23.

TABLE 23

| | | MFC/clay | Additional | | | | |
|---|---|---|---|---|---|---|---|
| | OCC | 50% POP | Filler | Thickness | Density | MOE | MOR |
| Example | wt % | wt % | wt % | cm | g · cm⁻³ | MPa | MPa |
| Control - no | 100 | 0 | 0 | 0.78 | 0.72 | 499.6 | 8.3 |
| sizing agent | | | | | | | |
| MFC board with | 90 | 10 | 0 | 0.64 | 0.84 | 953.3 | 14.6 |
| Rosin Size | | | | | | | |

The foregoing embodiments and advantages are merely exemplary and are not to be construed as limiting the present invention. Also, the description of the embodiments of the present invention is intended to be illustrative and not to limit the scope of the claims. Many alternatives, modifications, and variations will be apparent to those skilled in the art.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

The various embodiments described in this specification can be combined to provide further embodiments. Aspects of the embodiments can be modified, if necessary to employ concepts of the various patents, applications and publications to provide yet further embodiments.

The disclosures of each and every patent, patent application, publication, and accession number cited herein are hereby incorporated herein by reference in their entirety.

While the present disclosure has been disclosed with reference to various embodiments, it is apparent that other embodiments and variations of these may be devised by others skilled in the art without departing from the true spirit and scope of the disclosure. The appended claims are intended to be construed to include all such embodiments and equivalent variations. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

The foregoing written specification is considered to be sufficient to enable one skilled in the art to practice the embodiments. The foregoing description and Examples detail certain embodiments and describes the best mode contemplated by the inventors. It will be appreciated, however, that no matter how detailed the foregoing may appear in text, the embodiment may be practiced in many ways and should be construed in accordance with the appended claims and any equivalents thereof.

References discussed in the application are incorporated by reference in their entirety, for their intended purpose, which is clear based upon their context.

1.-57. (canceled)

58. A method of manufacturing a board or sheet comprising recycled cellulose-containing materials, a binder composition comprising microfibrillated cellulose and one or more inorganic particulate material, and optionally one or more additives, the method comprising the steps of:
(a) providing or obtaining a first aqueous slurry of recycled cellulose-containing materials, wherein the aqueous slurry is disintegrated at a consistency of 0.1 wt. % to 10 wt. %;
(b) providing or obtaining a second aqueous slurry of microfibrillated cellulose and one or more inorganic particulate materials, wherein the ratio of the one or more inorganic particulate materials to microfibrillated cellulose is about 99:5:0.5 to about 0.5:99.5, wherein the microfibrillated cellulose is obtained from virgin pulp or recycled cellulose-containing materials;
(c) mixing the first aqueous slurry of recycled cellulose-containing materials and second aqueous slurry of microfibrillated cellulose and one or more inorganic particulate material at a consistency of 0.1 to 25 wt. %, and adding any optional additives, wherein the mixture comprises 0.5 wt. % to 35 wt. % microfibrillated cellulose and one or more inorganic particulate material;
(d) pumping the mixture of step (c) to a suitably sized mould or former, the mould or former optionally comprising a press;
(e) draining and/or pressing and drying the board or sheet, wherein the board or sheet has an increased modulus of elasticity and modulus of rupture compared to a board or sheet prepared in a comparable method without microfibrillated cellulose.

59. The method according to claim 58, wherein the recycled cellulose-containing materials are old corrugated cardboard.

60. The method according to claim 58, wherein the recycled cellulose-containing materials are selected from the group consisting of recycled pulp or a papermill broke and/or industrial waste, or a paper stream rich in mineral fillers and cellulosic materials from a papermill, or a combination thereof.

61. The method according to claim 58, wherein the first aqueous slurry is disintegrated at a consistency of 1, 2, 3 or 4 wt %.

62. The method according to claim 58, wherein the disintegrating is performed in a disintegrator, a pulper or a refiner.

63. The method according to claim 58, wherein the disintegrating is performed until the CSF of the recycled cellulose-containing materials is from about 20 to about 700.

64. The method according to claim 62, wherein the disintegrating further comprises treating the slurry in a deflaker.

65. The method according to claim 58, wherein the ratio of the one or more inorganic particulate material to microfibrillated cellulose is about 80:20 or about 50:50.

66. The method according to claim 58, wherein the at least one or more inorganic particulate material is kaolin and/or calcium carbonate.

67. The method according to claim 66, wherein the calcium carbonate is precipitated calcium carbonate or ground calcium carbonate or a combination of both.

68. The method according to claim 58, wherein the at least one or more inorganic particulate material is a mixture of kaolin, ground calcium carbonate and precipitated calcium carbonate.

69. The method according to claim 58, wherein the at least one or more inorganic particulate material is selected from the group consisting of magnesium carbonate, dolomite, gypsum, halloysite, ball clay, metakaolin, fully calcined kaolin, talc, mica, perlite, diatomaceous earth, magnesium hydroxide, aluminium trihydrate, or combinations thereof.

70. The method according to claim 58, wherein some or all of the at least one inorganic particulate material is added with the recycled cellulose-containing materials of step (a).

71. The method according to claim 58, wherein the microfibrillated cellulose is made from virgin pulps comprising bleached or unbleached hardwood, softwood Kraft or sulphite pulps.

72. The method according to claim 58, wherein the microfibrillated cellulose is made from recycled cellulose-containing materials.

73. The method according to claim 58, wherein the mixture of step (c) comprises 5 wt. %, or 10 wt. % or 15 wt. % microfibrillated cellulose and one or more inorganic particulate material.

74. The method according to claim 58, wherein the board or sheet is formed into the shape of the structural component using compression molding; wherein the structural component is used in furniture or in an office structure.

75. The method according to claim 74, wherein the structural component is part of a frame for a couch, chair, or recliner, or a desk, storage unit, cupboard unit or modular furniture unit.

76. The method according to claim 58, wherein the board or sheet has improved strength to accept fasteners.

77. The method according to claim 58, wherein the board or sheet is a ceiling tile, wall board, or insulation board.

78. The method according to claim 58, wherein the board or sheet is a foam manufactured using one or more additive.

79. The method according to claim 58, wherein the board or sheet is manufactured using one or more additive.

80. The method according to claim 79, wherein the additive is a retention aid, drainage aid, formation aid, sizing aid or leveling aid.

81. The method according to claim 80, wherein the retention aid is selected from medium-to-high charge density, very high molecular weight, cationic polymers.

82. The method according to claim 80, wherein the drainage aid is selected from microparticles such as bentonite or silica, or medium-to-high charge density, very high molecular weight cationic polymers.

83. The method according to claim 80, wherein the formation aid is selected from anionic or nonionic dispersing agents, such as, polyethylene oxide or anionic polyacrylamide.

84. The method according to claim 80, wherein the sizing aid is selected from modified starch, hydrocolloids for surface sizing, alkyl succinic anhydride, alkyl ketene dimer and rosin for internal sizing.

85. The method according to claim 58, wherein the aqueous slurry is disintegrated at a consistency of 0.5 wt. % to 5 wt. %.

86. The method according to claim 58, wherein the ratio of the one or more inorganic particulate material to microfibrillated cellulose is about 80:20 to about 50:50.

87. The method according to claim 58, wherein the slurry of recycled cellulose-containing materials and second aqueous slurry of microfibrillated cellulose and one or more inorganic particulate material is mixed at a consistency of 0.5 to 10 wt. %

88. The method according to claim 58, wherein the mixture comprises 0.5 wt. % to 10 wt. % microfibrillated cellulose and one or more inorganic particulate material.

89. The method according to claim 58, wherein the board or sheet has an increased modulus of elasticity of at least 5% and/or increased modulus of rupture of at least 5% compared to a board prepared in a comparable method without microfibrillated cellulose.

90. The method according to claim 58, wherein the board or sheet has an increased modulus of elasticity of at least 10% and/or increased modulus of rupture of at least 10% compared to a board prepared in a comparable method without microfibrillated cellulose.

91. The method according to claim 58, wherein the board or sheet has an increased modulus of elasticity of at least 15% and/or increased modulus of rupture of at least 15% compared to a board prepared in a comparable method without microfibrillated cellulose.

92. The method according to claim 58, wherein the board or sheet has an increased modulus of elasticity of at least 20% and/or increased modulus of rupture of at least 20% compared to a board prepared in a comparable method without microfibrillated cellulose.

93. The method according to claim 58, wherein the board or sheet has an increased modulus of elasticity of at least 25% and/or increased modulus of rupture of at least 25% compared to a board prepared in a comparable method without microfibrillated cellulose.

94. The method according to claim 58, wherein the microfibrillated cellulose has a fibre steepness of about 20 to about 50.

95. The method according to claim 58, wherein the board or sheet has a thickness of 1 to 25 mm, or 2 to 5 mm, or 3 to 4 mm, or 5 to 10 mm, or 10 to 15 mm, or 5 to 20 mm, or 20 to 25 mm

96. The method according to claim 58, wherein the board or sheet has two or more plies.

97. The method according to claim 79, wherein the additive is starch.

98. The method according to claim 19, wherein the additive is a rosin.
